(19) United States
(12) Patent Application Publication
(10) Pub. No.: US 2025/0280276 A1
(43) Pub. Date: Sep. 4, 2025

(54) BLUETOOTH SWITCHING METHOD AND APPARATUS, BLUETOOTH CONNECTION METHOD AND APPARATUS, AND ELECTRONIC DEVICE

(71) Applicant: GUANGDONG OPPO MOBILE TELECOMMUNICATIONS CORP., LTD., Dongguan (CN)

(72) Inventor: Ruitian HOU, Dongguan (CN)

(73) Assignee: GUANGDONG OPPO MOBILE TELECOMMUNICATIONS CORP., LTD., Dongguan (CN)

(21) Appl. No.: 19/084,443

(22) Filed: Mar. 19, 2025

Related U.S. Application Data
(63) Continuation of application No. PCT/CN2023/103173, filed on Jun. 28, 2023.

(30) Foreign Application Priority Data
Sep. 22, 2022 (CN) 202211160261.0

(51) Int. Cl. H04W 4/80; H04W 76/14; H04W 76/15; H04W 76/16

(52) U.S. Cl. CPC H04W 4/80; H04W 76/14; H04W 76/15; H04W 76/16

(57) ABSTRACT

A Bluetooth switching method, a Bluetooth connection method, and an electronic device are provided. The Bluetooth switching method is performed by an electronic device and/or a Bluetooth device, and includes: establishing a second Bluetooth connection between the electronic device and the Bluetooth device in a case where a first Bluetooth connection has been established between the electronic device and the Bluetooth device; and disconnecting the first Bluetooth connection after the second Bluetooth connection is successfully established.

### CROSS REFERENCE TO RELATED APPLICATIONS

This present disclosure is a continuation of International Patent Application No. PCT/CN2023/103173, filed Jun. 28, 2023, which claims priority to the Chinese Patent Application No. 202211160261.0, filed Sep. 22, 2022, both of which are herein incorporated by reference in their entireties.

### TECHNICAL FIELD

This present disclosure relates to the field of Bluetooth technologies, and in particular to a Bluetooth switching method, a Bluetooth connection method, and an electronic device.

### BACKGROUND

With the enrichment of people's lives, the number of electronic devices owned by a user has increased, and Bluetooth communication technologies have advanced rapidly. Currently, for the convenience of users' work and life, an electronic device may establish a Bluetooth connection with an external device, and communication modes of the Bluetooth connection may include more than one type.

### SUMMARY

In a first aspect, some embodiments of the present disclosure provide a Bluetooth switching method performed by an electronic device and/or a Bluetooth device. The method includes: establishing a second Bluetooth connection between the electronic device and the Bluetooth device in a case where a first Bluetooth connection has been established between the electronic device and the Bluetooth device; and disconnecting the first Bluetooth connection after the second Bluetooth connection is successfully established.

In a second aspect, some embodiments of the present disclosure provide a Bluetooth switching method performed by an electronic device. The method includes: establishing a second Bluetooth connection between the electronic device and a Bluetooth device in a case where a first Bluetooth connection has been established between the electronic device and the Bluetooth device; and transmitting preset data to the Bluetooth device via a data transmission channel after the second Bluetooth connection is successfully established and the data transmission channel is successfully established based on the second Bluetooth connection.

In a third aspect, some embodiments of the present disclosure provide a Bluetooth connection method performed by an electronic device and/or a Bluetooth device. The method includes: establishing the other Bluetooth connection between the electronic device and the Bluetooth device in the case where one Bluetooth connection has been established between the electronic device and the Bluetooth device, the two Bluetooth connections correspond to different Bluetooth communication modes, respectively; and disconnecting a target Bluetooth connection after obtaining connection information of the target Bluetooth connection of the two Bluetooth connections, the target Bluetooth connection being at least one of the two Bluetooth connections.

In a fourth aspect, some embodiments of the present disclosure provide an electronic device. The electronic device includes one or more processors, a memory, and one or more application programs. The one or more application programs stored in the memory and configured to be executed by the one or more processors to cause the electronic device to implement any one of the above methods.

### BRIEF DESCRIPTION OF THE DRAWINGS

In order to make the technical solutions described in embodiments of the present disclosure more clearly, the drawings used for description of some embodiments are described. Apparently, the drawings in the following description only illustrate some embodiments of the present disclosure. For those skilled in the art, other drawings may be acquired according to the drawings without any creative work.

FIG. 1 is a schematic diagram of an embodiment of a Bluetooth mode switching process according to the present disclosure.

FIG. 2 is a schematic diagram of another embodiment of a Bluetooth mode switching process according to the present disclosure.

FIG. 3 is a flowchart of an embodiment of a Bluetooth switching method according to the present disclosure.

FIG. 4 is a schematic diagram of a Bluetooth settings interface according to an embodiment of the present disclosure.

FIG. 5 is a schematic diagram of further another embodiment of a Bluetooth mode switching process according to the present disclosure.

FIG. 6 is a flowchart of another embodiment of a Bluetooth switching method according to the present disclosure.

FIG. 7 is a schematic diagram of still another embodiment of a Bluetooth mode switching process according to the present disclosure.

FIG. 8 is a block diagram of an embodiment of modules of a Bluetooth switching apparatus according to the present disclosure.

FIG. 9 is a flowchart diagram of further another embodiment of a Bluetooth switching method according to the present disclosure.

FIG. 10 is a block diagram of another embodiment of modules of a Bluetooth switching apparatus according to the present disclosure.

FIG. 11 is a block diagram of a structure of an electronic device according to an embodiment of the present disclosure.

FIG. 12 is schematic diagram of a storage unit for saving or carrying a program code implementing an image display method according to an embodiment of the present disclosure.

FIG. 13 is a block diagram of modules of a computer product according to an embodiment of the present disclosure.

### DETAILED DESCRIPTIONS

In order to better understand the present disclosure for those skilled in the art, the technical solutions in embodiments of the present disclosure are clearly and completely described in conjunction with the drawings in the embodiments of the present disclosure. It is obvious that the described embodiments are only some embodiments of the present disclosure, and not all embodiments. The components of the embodiments of the present disclosure described and shown in the drawings may be arranged and designed in various configurations. Therefore, the following detailed description of some embodiments of the present disclosure in the drawings is not intended to limit the scope of the present disclosure but merely represents selected embodiments. All other embodiments acquired by those skilled in the art based on the embodiments in the present disclosure without the creative work are all within the scope of the present disclosure.

It should be noted that similar reference numerals and letters in the following drawings represent similar items. Therefore, once an item is defined in one drawing, the item is not required further defined or explained in subsequent drawings. In addition, in the description of the present disclosure, terms such as “first,” “second”, etc., are used only for distinguishing descriptions and should not be understood as indicating or implying relative importance. The embodiments, implementations, and technical features of the present disclosure may be combined in a case where they are in conflict with each other.

The Internet of Things (IoT) extends and expands the concept of the “Internet” to include communication and information exchange between items. With the development of the IoT technologies, certain scenarios may be configured in the IoT systems. For the configured scenarios, multiple smart devices may be involved, and these devices may have an interactive relationship to achieve collaborative work. For example, the configured scenarios may include following. When one device approaches another device, at least one of the two devices performs a specified operation. Alternatively, when one device performs an operation, part of the data of the operation is processed by itself, and another part of the data of the operation is processed by another device.

With the enrichment of people's lives, the number of electronic devices owned by a user has increased, and Bluetooth communication technologies have advanced rapidly. Currently, for the convenience of users' work and life, an electronic device may establish a Bluetooth connection with an external device, enabling the user to control the electronic device to send data to the connected device. The electronic device may be a smartphone, a tablet, an e-reader, a wireless audio playback device, a display, or other device with a built-in Bluetooth module and capable of establishing a Bluetooth connection and interacting with other Bluetooth devices via data. The wireless audio playback device may include a Bluetooth headphone or a Bluetooth speaker.

Currently, the Bluetooth protocol supports multiple Bluetooth communication modes, including a classic Bluetooth mode and low-energy audio Bluetooth (LE Audio) mode. The classic Bluetooth mode includes a basic rate (BR) mode, an enhanced data rate (EDR) mode, and a high speed (HS) mode. The BR mode is also called Bluetooth 1.0, the EDR mode is also called Bluetooth 2.0, and the HS mode is also called Bluetooth 3.0. The LE Audio mode is a Bluetooth audio transmission mode working under a Bluetooth Low Energy (BLE) mode, and uses a new low complexity communication codec (LC3) to achieve higher audio quality and lower power consumption. Compared to the classic Bluetooth audio codec, i.e., a subband codec (SBC), LC3 provides greater encoding efficiency and quality, such that the LE Audio mode has greater technical advantages than the classic Bluetooth audio technology.

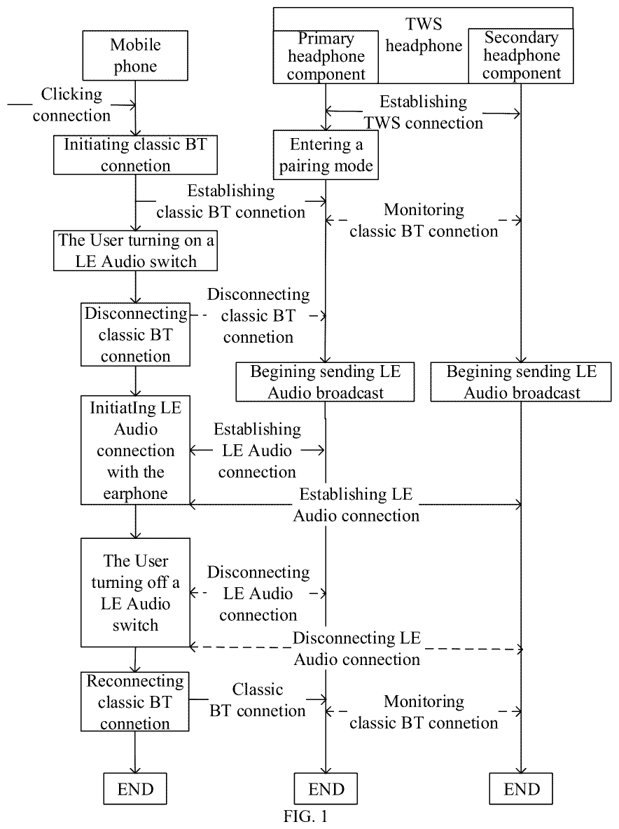

However, in researches, the inventor has found that since the Bluetooth communication between devices supports multiple Bluetooth modes, switching between these modes may easily cause stuttering, excessively long wait times, or interruptions in the Bluetooth communication. In some embodiments, as shown in FIG. 1, taking the Bluetooth connection between a mobile phone and a wireless headphone as an example, the above technical problems may exist in switching between multiple Bluetooth modes. In the related art, in a case where a headphone has established a classic Bluetooth connection with a mobile phone, when the user turns on the LE Audio switch in the a Bluetooth settings interface of the mobile phone, the mobile phone first actively disconnects a current classic Bluetooth connection with the headphone and then initiate a LE Audio connection request with the headphone. The mobile phone completes the LE Audio connection with the headphone after scanning a low energy (LE) broadcast sent by the two headphone components of the headphone. When the user turns off the LE Audio switch, the mobile phone first disconnects the current LE Audio connection with the headphone and then is reconnected to the headphone via the classic Bluetooth to complete the classic Bluetooth connection, thereby achieving dynamic switching between the classic Bluetooth mode and the LE Audio mode.

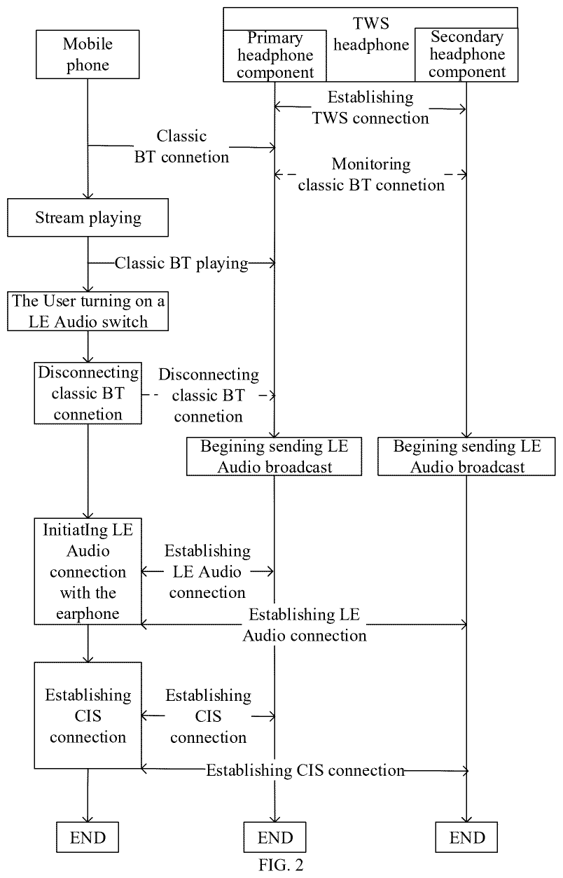

However, in the current operating system, since an existing Bluetooth link is required to be disconnected before a new Bluetooth link is established, the connection method shown in FIG. 1 has the following technical problems. In one scenario, if the mobile phone is required to switch from a classic Bluetooth connection to a LE Audio connection (also called a LE Audio Bluetooth connection), the mobile phone first actively disconnects the classic Bluetooth connection with the headphone and then initiate a LE Audio connection with the headphone, and vice versa. However, this mechanism that disconnection is performed before connection carries instability risks. For example, after the classic Bluetooth connection is disconnected, the mobile phone may fail to establish the LE Audio connection with the headphone; or after the LE Audio connection disconnected, the mobile phone may fail to establish to the classic Bluetooth connection. This may result in the headphone and the mobile phone being in a disconnected state due to the inability to connect to the desired Bluetooth communication mode, reducing the user experience. In another scenario, in a case where the mobile phone transmits data via an established Bluetooth link, for example, in a case where the mobile phone has established a classic Bluetooth connection with a wireless headphone and plays audio data such as music or calls via the headphone, when the mobile phone is required to switch from the classic Bluetooth connection to the LE Audio connection, as shown in FIG. 2, the mobile phone first disconnects the classic Bluetooth connection and then establishes the LE Audio connection with the headphone; subsequently, the mobile phone establishes a connected isochronous stream (CIS) for stream playing under the LE Audio mode, and vice versa. This entire process not only takes a long time but may also result in prolonged audio silence during switching the Bluetooth communication mode. Additionally, there is a risk of the mobile phone failing to establish the LE Audio connection, causing a situation where the audio plays on the mobile phone, and the headphone is in silence, reducing the user experience.

Therefore, to solve these technical problems, some embodiments of the present disclosure provide a Bluetooth switching method, an apparatus, an electronic device, and a computer-readable medium to maintain an established Bluetooth link until a new Bluetooth link is established during switching Bluetooth communication modes between an electronic device and a Bluetooth device, thereby improving the user experience.

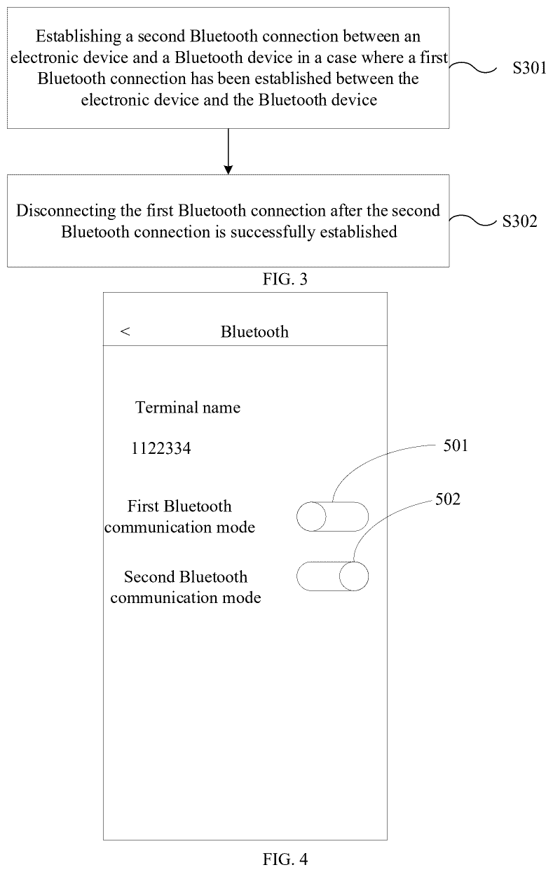

As shown in FIG. 3, some embodiments of the present disclosure provide a Bluetooth switching method, performed by a communication system. The communication system includes an electronic device and a Bluetooth device. The electronic device may be the aforementioned smartphone, and the Bluetooth device may be the aforementioned wireless headphone. In some embodiments, the performing subject of the method may be the electronic device, the Bluetooth device, or both the electronic device and the Bluetooth device via interaction, which is not limited herein. The Bluetooth switching method may include operations S301 to S303.

The operation S301 may include: establishing a second Bluetooth connection between an electronic device and a Bluetooth device in a case where a first Bluetooth connection has been established between the electronic device and the Bluetooth device.

It should be noted that in some embodiments of the present disclosure, the Bluetooth connection may include a Bluetooth communication link established based on a Bluetooth communication protocol. In some embodiments, establishing a Bluetooth connection may include establishing a Bluetooth physical link. In some embodiments, establishing a Bluetooth connection may include establishing a Bluetooth logical link, such as an asynchronous connection-oriented link (ACL). In some embodiments, establishing a Bluetooth connection may include establishing an audio transmission protocol or other data transmission protocols based on the aforementioned link, such as an advanced audio distribution profile (A2DP) and a hands-free profile (HFP). In some embodiments, successfully establishing a Bluetooth connection does not include establishing certain audio transmission channels, such as a synchronous connection-oriented (SCO) link or a CIS, such audio transmission channels are established when there is a relevant audio service or a preset condition. In other words, the audio transmission channels are not immediately established when the Bluetooth connection is established, a corresponding audio transmission channel is established only when triggered by a service to facilitate the transmission of the relevant service. It should be understood that different Bluetooth communication modes may be suitable for different Bluetooth protocols, so that the corresponding communication links and transmission protocols may be different, which may refer to the relevant Bluetooth standards. Some processes related to the Bluetooth connection may refer to the relevant Bluetooth standards and may change as these standards evolve. It should be understood that in some embodiments, disconnecting a Bluetooth connection may correspond to establishing a Bluetooth connection. In some embodiments, disconnecting a Bluetooth connection and establishing a Bluetooth connection may have different meanings. For example, establishing a Bluetooth connection may refer to establishing a logical link such as ACL, while disconnecting a Bluetooth connection may refer to disconnecting the logical link and an upper-layer communication protocol. Generally, after an underlying link is disconnected, an upper-layer protocol is disconnected. In some embodiments, disconnecting a Bluetooth connection may mean that all Bluetooth communication links between two devices are disconnected. In some embodiments, disconnecting a Bluetooth connection may mean that an upper-layer protocol is disconnected. In some embodiments, disconnecting a Bluetooth connection may mean that the two devices may cannot perform point-to-point transmission based on the Bluetooth link. A first Bluetooth connection and a second Bluetooth connection correspond to different Bluetooth communication modes. For example, a Bluetooth communication mode corresponding to one of the first Bluetooth connection and the second Bluetooth connection is a classic Bluetooth mode, and a Bluetooth communication mode corresponding to the other Bluetooth connection is a low-energy audio Bluetooth mode (i.e., the aforementioned LE Audio mode). For example, in some embodiments, a Bluetooth communication mode corresponding to the first Bluetooth connection is a classic Bluetooth mode which may mean that the first Bluetooth connection is a classic Bluetooth connection. In some embodiments, a Bluetooth communication mode corresponding to the second Bluetooth connection is the LE Audio mode, which may mean that the second Bluetooth connection is a low-energy audio Bluetooth connection. In some embodiments, a Bluetooth communication mode corresponding to the first Bluetooth connection is a LE Audio mode, and a Bluetooth communication mode corresponding to the second Bluetooth connection is a classic Bluetooth mode.

As an example, an electronic device and a Bluetooth device may simultaneously establish two Bluetooth connections corresponding to different communication modes, such that the first established Bluetooth connection may serve as a first Bluetooth connection. In a case where the first Bluetooth connection has been established and the other Bluetooth connection is still being established, the other Bluetooth connection may serve as a second Bluetooth connection. In other words, in a case where the first Bluetooth connection has been established between the electronic device and the Bluetooth device, the second Bluetooth connection is established between the electronic device and the Bluetooth device. As another example, in a case where the first Bluetooth connection has been established between the electronic device and the Bluetooth device, the electronic device or the Bluetooth device may perform a Bluetooth switching operation based on a request. That is, in a case where the first Bluetooth connection has been established between the electronic device and the Bluetooth device, a designated request is determined, and the second Bluetooth connection is established between the electronic device and the Bluetooth device in response to the designated request. The designated request is configured to indicate the establishment of the second Bluetooth connection between the electronic device and the Bluetooth device. In some embodiments, the designated request may be understood as a request configured to trigger switching a Bluetooth mode.

It should be noted that the designated request may be input by the user via the electronic device or the Bluetooth device. In some embodiments, the designated request may be automatically generated based on a preset application scenario. The designated request may be a particular indication generated based on a user operation or the preset application scenario. The preset application scenario may include a game application scenario, a video playback scenario, or other predefined scenarios, which is not limited herein. In some embodiments, taking the designated request being input by a user as an example, the user may input the designated request via the electronic device or the Bluetooth device. In some embodiments, the electronic device may determine the designated request. The electronic device may display a Bluetooth settings interface, which includes switches for different Bluetooth communication modes to turn a corresponding Bluetooth communication mode on or off. As shown in FIG. 4, the Bluetooth settings interface may include a first switch 501 corresponding to the first Bluetooth communication mode and a second switch 502 corresponding to the second Bluetooth communication mode. The first switch is set as the “on” state to request the establishment of a Bluetooth connection corresponding to the first Bluetooth communication mode, while the second switch is set as the “on” state to request the establishment of a Bluetooth connection corresponding to the second Bluetooth communication mode between the electronic device and the Bluetooth device. In some embodiments, a designated switch may be set in the Bluetooth settings interface. The default Bluetooth mode between the electronic device and the Bluetooth device is the first Bluetooth communication mode. When the designated switch is turned on, the electronic device and the Bluetooth device establish the second Bluetooth connection based on the second Bluetooth communication mode. When the designated switch is turned off, the electronic device and the Bluetooth device establish the first Bluetooth connection based on the first Bluetooth communication mode. Thus, the designated request may be input via the aforementioned second switch 502 or the designated switch.

In some embodiments, the Bluetooth device may determine the designated request. In a case where the Bluetooth device has a screen, the Bluetooth device may obtain the designated request via the Bluetooth settings interface similar to the electronic device. In a case where the Bluetooth device does not have a screen or the screen does not meet the display requirement for the Bluetooth device interface, other methods may be configured to determine the designated request. The other methods may include at least one of gesture detection and voice detection.

The operation S302 may include: disconnecting the first Bluetooth connection after the second Bluetooth connection is successfully established.

It should be noted that during the process of establishing the second Bluetooth connection between the electronic device and the Bluetooth device, the first Bluetooth connection between the electronic device and the Bluetooth device is remained. For example, the implementation of establishing the second Bluetooth connection between the electronic device and the Bluetooth device may includes following operations. In a case where the first Bluetooth connection between the electronic device and the Bluetooth device is maintained, the Bluetooth device continuously sends a preset broadcast, the preset broadcast is configured to establish the second Bluetooth connection; the electronic device scans the preset broadcast sent by the Bluetooth device and establishes the second Bluetooth connection with the Bluetooth device based on the preset broadcast. For example, the preset broadcast may carry the Bluetooth address of the Bluetooth device. The electronic device parses the preset broadcast to obtain the Bluetooth address of the Bluetooth device and establishes the second Bluetooth connection based on the Bluetooth address.

A Bluetooth communication mode corresponding to one of the first Bluetooth connection and the second Bluetooth connection is a classic Bluetooth mode, and the other Bluetooth communication mod is the LE Audio mode. It is assumed that a Bluetooth communication mode corresponding to the first Bluetooth connection is classic Bluetooth mode, a Bluetooth communication mode corresponding to the second Bluetooth connection is the LE Audio mode, the electronic device is a mobile phone, the Bluetooth device is a Bluetooth headphone, and the Bluetooth headphone may be a true wireless stereo (TWS) headphone. For example, for a classic Bluetooth mode, the Bluetooth headphone may be in a pairing state. In a case where the Bluetooth headphone is in the pairing state, the Bluetooth headphone may be discovered by other devices. In a case where other devices have never established a Bluetooth connection with the Bluetooth headphone or have not obtained the Bluetooth address of the headphone in advance, other devices need to pair with the headphone. That is, by the way of pairing, the headphone and the device that requests to establish exchange communication information, including communication addresses and other data configured to establish connection. Therefore, for a new device, only when in an inquiry scan state, the Bluetooth headphone can be discovered by other devices, pair with other devices and then complete the Bluetooth connection.

In some embodiments, a headphone component of a TWS headphone that establishes a classic Bluetooth connection with the electronic device is a primary headphone component. The primary headphone component may serve as the Bluetooth device to perform the methods described in some embodiments of the present disclosure. In some embodiments, the TWS headphone may serve as a whole. The classic Bluetooth connection may be established between the primary headphone component and the electronic device, while the LE Audio Bluetooth connection may be established separately between the electronic device and each of the two headphone components of the TWS headphone. In some embodiments, the LE Audio Bluetooth connection may be established via a monitoring manner. For example, the primary headphone component may establish a classic Bluetooth connection and/or a LE Audio Bluetooth connection with the electronic device, while the secondary headphone component may establish the aforementioned classic Bluetooth connection or LE Audio Bluetooth connection via monitoring.

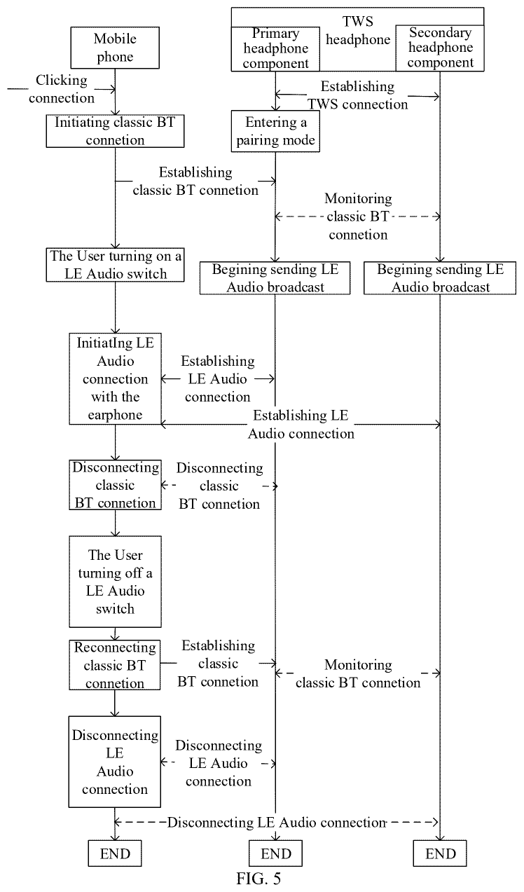

As shown in FIG. 5, in a case where the Bluetooth headphone enters the pairing state, the Bluetooth headphone may be in a page scan state. In some embodiments, both page scan and inquiry scan may be enabled in the pairing state. The mobile phone sends a page packet, and the Bluetooth headphone scans the page request sent by the mobile phone to establish a classic Bluetooth connection between the Bluetooth device and the mobile phone.

When the user turns on the LE Audio switch, the mobile phone may detect that the LE Audio switch is in the “on” state. For example, the LE Audio switch is the second switch 502 in the aforementioned interface. When the LE Audio switch is turned on, a first request (which may be understood as an example of the designated request) is triggered. The first request is configured to indicate the establishment of a LE Audio Bluetooth connection (e.g., corresponding to the second Bluetooth connection) between the electronic device and the Bluetooth device. The LE Audio Bluetooth connection may be understood as a Bluetooth connection established based on the LE Audio Bluetooth protocol. The mobile phone begins scanning the LE Audio broadcast (e.g., the LE Audio broadcast is a low-energy Bluetooth broadcast configured to establish a LE Audio Bluetooth connection) sent by the headphone based on the designated request. The LE Audio broadcast may include the access address of the LE Audio mode of the headphone, such as the BLE address. The mobile phone then establishes a LE Audio connection with the headphone based on the LE Audio broadcast. For example, for a dual-mode Bluetooth headphone, the headphone may include a primary headphone component and a secondary headphone component based on the connection relationship with the electronic device (e.g., the mobile phone) in the classic Bluetooth mode. The mobile phone scans the LE Audio broadcast sent by the primary headphone component and the LE Audio broadcast sent by the secondary headphone component, respectively, and establishes a LE Audio connection with the primary headphone component and a LE Audio connection with the secondary headphone component. For example, in the LE Audio mode, there may be no distinction between primary and secondary headphone components. The mobile phone then disconnects the classic Bluetooth connection between the mobile phone and the headphone. At this time, the Bluetooth connection between the mobile phone and the Bluetooth headphone is the LE Audio connection.

It should be understood that in some embodiments, a classic Bluetooth connection may be understood as a Bluetooth connection established based on the classic Bluetooth protocol, and a LE Audio Bluetooth connection may be understood as a Bluetooth connection established based on the LE Audio Bluetooth protocol.

In some embodiments, in a case where the Bluetooth connection between the mobile phone and the Bluetooth headphone is a LE Audio connection, when the LE Audio switch is switched to the “off” state, a second request (e.g., corresponding to the designated request) is detected. The second request may be configured to indicate the establishment of a classic Bluetooth connection between the electronic device (e.g., the mobile phone) and the Bluetooth device. Thus, the mobile phone establishes the classic Bluetooth connection between the mobile phone and the Bluetooth headphone. For example, the mobile phone may establish the classic Bluetooth connection again. It should be understood that after the mobile phone and the Bluetooth headphone establish the classic Bluetooth connection for the first time, the mobile phone may generate a connection record. The connection record may include the Bluetooth address of the headphone, and pairing keys, etc., so that the mobile phone may directly be reconnected to the headphone later based on the Bluetooth address. The reconnecting may refer to establishing a Bluetooth connection with a previously connected device directly without operations like inquiry or pairing. For example, the mobile phone may send a page packet to the Bluetooth headphone to request the establishment of a classic Bluetooth connection. The reconnection operation may refer to the relevant Bluetooth standards.

For example, in a case where the performing subject of this method is the electronic device and the first Bluetooth connection has been established between the electronic device and the Bluetooth device, the electronic device triggers the designated request, responds to the designated request, and establishes the second Bluetooth connection between the electronic device and the Bluetooth device. The electronic device maintains the first Bluetooth connection between the electronic device and the Bluetooth device. Then, after the second Bluetooth connection is successfully established, the electronic device disconnects the first Bluetooth connection. In some embodiments, taking the first Bluetooth connection being a classic Bluetooth connection and the second Bluetooth connection being a LE Audio connection as an example, in a case where the classic Bluetooth connection has been established between the electronic device and the Bluetooth device, the electronic device triggers the designated request, for example, the user inputs a first request by operating the LE Audio switch on the electronic device. The electronic device begins scanning the LE Audio broadcast sent by the Bluetooth device based on the first request to establish the LE Audio connection after scanning the broadcast. In addition, the classic Bluetooth connection between the electronic device and the Bluetooth device is required to be maintained. Then, after it is determined that the LE Audio connection is successfully established, the electronic device actively disconnects the classic Bluetooth connection between the electronic device and the Bluetooth device. In other embodiments, taking the first Bluetooth connection being a LE Audio connection and the second Bluetooth connection being a classic Bluetooth connection as an example, in a case where the LE Audio connection has been established between the electronic device and the Bluetooth device, the user inputs a second request by operating the LE Audio switch on the electronic device. The electronic device establishes the classic Bluetooth connection again and maintains the LE Audio connection between the electronic device and the Bluetooth device. After it is determined that the classic Bluetooth connection is successfully established, the electronic device actively disconnects the LE Audio connection between the electronic device and the Bluetooth device.

For example, in a case where the performing subject of this method is the Bluetooth device and the first Bluetooth connection has been established between the electronic device and the Bluetooth device, the Bluetooth device triggers the designated request, responds to the designated request, and establishes the second Bluetooth connection between the electronic device and the Bluetooth device. The Bluetooth device maintains the first Bluetooth connection between the electronic device and the Bluetooth device. Then, after the second Bluetooth connection is successfully established, the Bluetooth device disconnects the first Bluetooth connection. In some embodiments, taking the first Bluetooth connection being a classic Bluetooth connection and the second Bluetooth connection being a LE Audio connection as an example, in a case where the classic Bluetooth connection has been established between the electronic device and the Bluetooth device, the Bluetooth device triggers the designated request, for example, the user inputs a first request by operating the Bluetooth device via voice or gesture. The Bluetooth device begins sending the LE Audio broadcast based on the first request, so that the Bluetooth device may establish the LE Audio connection after scanning the LE Audio broadcast. In addition, the classic Bluetooth connection between the electronic device and the Bluetooth device is required to be maintained. Then, after it is determined that the LE Audio connection is successfully established, the Bluetooth device actively disconnects the classic Bluetooth connection between the electronic device and the Bluetooth device. In other embodiments, taking the first Bluetooth connection being a LE Audio connection and the second Bluetooth connection being a classic Bluetooth connection as an example, in a case where the LE Audio Bluetooth connection has been established between the electronic device and the Bluetooth device, the user inputs a second request by operating the LE Audio switch on the Bluetooth device. The Bluetooth device establishes the classic Bluetooth connection again and maintains the LE Audio connection between the electronic device and the Bluetooth device. After it is determined that the classic Bluetooth connection is successfully established, the Bluetooth device actively disconnects the LE Audio connection between the electronic device and the Bluetooth device.

For example, in a case where the performing subject of this method is the electronic device and the Bluetooth device, i.e., the method is an interactive process between the electronic device and the Bluetooth device, and the first Bluetooth connection has been established between the electronic device and the Bluetooth device, the electronic device triggers the designated request and sends the designated request to the Bluetooth device. The Bluetooth device responds to the designated request and establishes the second Bluetooth connection between the electronic device and the Bluetooth device. The Bluetooth device maintains the first Bluetooth connection between the electronic device and the Bluetooth device. Then, after the second Bluetooth connection is successfully established, the electronic device disconnects the first Bluetooth connection. It should be noted that in a case where the performing subject is the electronic device and the Bluetooth device, besides the aforementioned interactive process, other methods may be used, as long as the aforementioned method may be performed in an interaction manner. The method may vary depending on the functions of the electronic device and the Bluetooth device or the Bluetooth protocols or standards configured to establish the Bluetooth connection, which is not limited herein.

It should be noted that the first Bluetooth connection may correspond to the LE Audio mode, and the second Bluetooth connection may correspond to the classic Bluetooth mode. The connection method may refer to the aforementioned description and will not be repeated here.

Therefore, in some embodiments of the present disclosure, the second Bluetooth connection may be established between the electronic device and the Bluetooth device in a case where the first Bluetooth connection has been established between the electronic device and the Bluetooth device, and the first Bluetooth connection may be disconnected after the second Bluetooth connection is successfully established. In other words, the first Bluetooth connection may be maintained during the establishment of the second Bluetooth connection, and the first Bluetooth connection may be disconnected only after the second Bluetooth connection is successfully established. This reduces stuttering during switching from the first Bluetooth connection to the second Bluetooth connection and avoids excessive power consumption and wide occupied bandwidth caused by maintaining both the first and second Bluetooth connections simultaneously. It should be noted that a data transmission channel may be established based on the second Bluetooth connection, and the electronic device and the Bluetooth device may transmit data through this channel. The data transmission channel may refer to the description in subsequent embodiments. Therefore, regarding whether the electronic device and the Bluetooth device transmit data via the first Bluetooth connection, it is necessary to consider whether the data will cause stuttering during switching Bluetooth connection, so as to choose a reasonable moment to disconnect the first Bluetooth connection. For example, in a case where the first Bluetooth connection has been established and the electronic device and the Bluetooth device do not transmit data via the first Bluetooth connection, the first Bluetooth connection may be disconnected after the second Bluetooth connection is successfully established and the data transmission channel is established on the second Bluetooth connection. In other words, in a case where the second Bluetooth connection is successfully established and the data transmission channel is established on the second Bluetooth connection, the first Bluetooth connection may be disconnected. In this way, the data transmission channel of the second Bluetooth connection is established in advance, such that the established channel may be used directly for subsequent data transmission without establishing a channel later. Moreover, in a case where the purpose of selecting the second Bluetooth connection between the electronic device and the Bluetooth device is to transmit data, for example, the second Bluetooth connection offers better stability and quality for data transmission compared to the first Bluetooth connection, then even if the electronic device and the Bluetooth device do not use the first Bluetooth connection to transmit data, when the second Bluetooth connection is successfully established, it may be considered that the electronic device and the Bluetooth device have a high probability to use the second Bluetooth connection for data transmission. Therefore, the data transmission channel may be established in advance, the first Bluetooth connection may be disconnected after the channel is successfully established. In this way, switching from the first Bluetooth connection to the second Bluetooth connection is completed.

In some embodiments, in a case where the first Bluetooth connection has been established and the electronic device and the Bluetooth device do not transmit data through the first Bluetooth connection, i.e., there is no concern about stuttering during switching to the second Bluetooth connection, the first Bluetooth connection may be disconnected after the second Bluetooth connection is successfully established but before the data transmission channel is established on the second Bluetooth connection. In other words, in a case where preset data is not transmitted via the first Bluetooth connection, the implementation of disconnecting the first Bluetooth connection after the second Bluetooth connection is successfully established may includes: disconnecting the first Bluetooth connection after the second Bluetooth connection is successfully established but before the data transmission channel is established on the second Bluetooth connection. That is, in a case where it is determined that the second Bluetooth connection is not required to take over the data transmission from the first Bluetooth connection, the first Bluetooth connection may be disconnected before the data transmission channel is successfully established on the second Bluetooth connection.

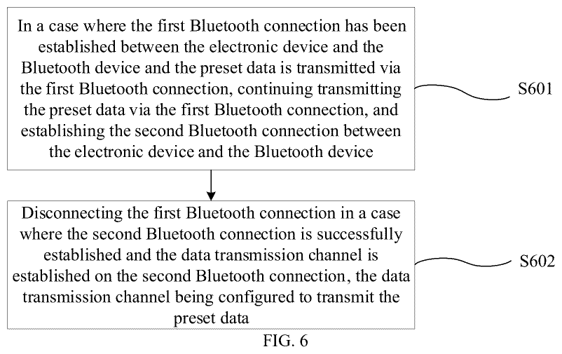

In some embodiments, in a case where the first Bluetooth connection has been established and the electronic device and the Bluetooth device transmit data via the first Bluetooth connection, the Bluetooth switching method shown in FIG. 6 may be referred.

As shown in FIG. 6, some embodiments of the present disclosure provide a Bluetooth switching method, performed by a communication system. The communication system includes an electronic device and a Bluetooth device. The electronic device may be the aforementioned smartphone, and the Bluetooth device may be the aforementioned wireless headphone. In some embodiments, the performing subject of the method may be the electronic device, the Bluetooth device, or both the electronic device and the Bluetooth device via interaction, which is not limited herein. The Bluetooth switching method may include operations S601 to S603.

The operation S601 may include: in a case where the first Bluetooth connection has been established between the electronic device and the Bluetooth device and the preset data is transmitted via the first Bluetooth connection, continuing transmitting the preset data via the first Bluetooth connection, and establishing the second Bluetooth connection between the electronic device and the Bluetooth device.

It should be noted that the preset data may be data (e.g., music data, call data, or voice data, etc.) that is sent by the electronic device to the Bluetooth device via Bluetooth communication between the electronic device and the Bluetooth device and performed preset processing by the Bluetooth device. For example, the preset processing may include an operation such as storage or playback. In some embodiments, the processing manner of the Bluetooth device may include processing the preset data while receiving it, i.e., the electronic device and the Bluetooth device transmit and process the preset data in real time. In some embodiments, the processing manner of the Bluetooth device may not be in real time, i.e., the preset data is transmitted first, and the preset data is processed after the amount of the transmitted preset data meets a preset value. Therefore, to avoid interruption of processing the preset data by the Bluetooth device caused by interruption of data transmission, the stability and continuity of Bluetooth communication between the electronic device and the Bluetooth device is required to be maintained.

For example, in a case where the first Bluetooth connection has been established between the electronic device and the Bluetooth device and the preset data is transmitted via the first Bluetooth connection, the second Bluetooth connection between the electronic device and the Bluetooth device may be established based on the designated request. Thus, in a case where the first Bluetooth connection has been established between the electronic device and the Bluetooth device and the preset data is transmitted via the first Bluetooth connection, the designated request is determined, in response to the designated request, the preset data is transmitted continually via the first Bluetooth connection, and the second Bluetooth connection between the electronic device and the Bluetooth device is established.

In some embodiments, the second Bluetooth connection is established in response to the designated request, in a case where the preset data is transmitted via the first Bluetooth connection, the preset data cannot be transmitted before the second Bluetooth connection is not established. Therefore, the preset data is required to be transmitted continually via the first Bluetooth connection. In a case where the first Bluetooth connection is a LE Audio Bluetooth connection, taking the preset data being music data or call data as an example, the preset data being transmitted continually via the first Bluetooth connection may be understood as establishing a CIS link based on the first Bluetooth connection and transmitting the preset data via the CIS link. In a case where the first Bluetooth connection is a classic Bluetooth connection and the preset data is call data, the preset data being transmitted continually via the first Bluetooth connection may be understood as establishing an SCO link based on the first Bluetooth connection and transmitting the preset data via the SCO link. The corresponding transmission link may be determined based on the type of the preset data, the used Bluetooth mode, and a relevant regulation of a corresponding a Bluetooth standard. In a case where the first Bluetooth connection is maintained, when receiving the designed request, the electronic device may continue transmitting the preset data via the first Bluetooth connection and establish the second Bluetooth connection between the electronic device and the Bluetooth device, ensuring that the user may still hear audio during the establishment of the second Bluetooth connection.

The operation S602 may include: disconnecting the first Bluetooth connection in a case where the second Bluetooth connection is successfully established and the data transmission channel is established on the second Bluetooth connection. The data transmission channel is configured to transmit the preset data.

In a case where the preset data is transmitted between the electronic device and the Bluetooth device via the first Bluetooth connection, when the preset data is required to be transmitted via the second Bluetooth connection between the electronic device and the Bluetooth device, the data transmission channel of the second Bluetooth connection may be established. The electronic device and the Bluetooth device may transmit the preset data via this channel. In some embodiments, the data transmission channel may be configured to transmit other data supported by this channel, which is not limited herein.

It should be understood that preset data may have multiple types, such as music data, call data, and voice data, etc. For different Bluetooth modes, different transmission links may be uses for these types of preset data. For example, for call data and other data that requires high real-time performance, in a classic Bluetooth mode, the preset data may be transmitted via the SCO link; in the LE Audio mode, the preset data may be transmitted via the CIS link. For music data and other data that requires high playback quality, in the classic Bluetooth mode, the preset data may be transmitted via the ACL based on the A2DP protocol; in the LE Audio mode, the preset data may be transmitted via the CIS link, which may refer to the relevant Bluetooth standards. For some links such as SCO or CIS, they may be established only when there is a service demand. For example, in the classic Bluetooth mode, the SCO link is established only when there is a call service and is disconnected after the service ends, saving power to some extent. Similarly, in the LE Audio mode, the CIS link is established only when there is a music or call playback service and is disconnected after the service ends. Establishing SCO or CIS audio transmission channels takes time. Therefore, in a case where preset data is transmitted via the first Bluetooth connection, the first Bluetooth connection may be disconnected only after the audio transmission channel (e.g., SCO or CIS) is established based on the second Bluetooth connection, enabling audio transmission to be quickly switched to the second Bluetooth connection, reducing the interruption perceived by the user during switching the Bluetooth mode, thereby improving the user experience. In some embodiments, in a case where the Bluetooth mode corresponding to the second Bluetooth connection is a classic Bluetooth mode and the preset data is music data or other data that is transmitted via the ACL, the first Bluetooth connection may be disconnected after the second Bluetooth connection is established. The second Bluetooth connection may include the ACL and the A2DP protocol connection.

In some embodiments, in a case where the second Bluetooth connection corresponds to a classic Bluetooth mode and the preset data is music data or other data that is transmitted via the ACL, establishing the second Bluetooth connection may be understood as establishing the ACL, and establishing the data transmission channel may be understood as establishing the A2DP protocol based on the ACL. Thus, the first Bluetooth connection may be disconnected after the A2DP protocol is established.

It should be understood that for some preset data, a data transmission channel is required to be established only when there is a service demand. Therefore, to avoid the user perceiving prolonged playback interruptions caused by disconnecting the first Bluetooth connection before establishing the data transmission channel of the second Bluetooth connection, disconnecting the first Bluetooth connection after the data transmission channel of the second Bluetooth connection is established provides a better user experience. In some embodiments, the first Bluetooth connection may be disconnected after the transmission of preset data has been switched to the data transmission channel of the second Bluetooth connection, thereby further reducing the interruption perceived by the user during switching. Disconnecting the first Bluetooth connection may save bandwidth, further ensuring the stability of data transmission based on the second Bluetooth connection and thereby ensuring stable playback. In some embodiments, after the electronic device and the Bluetooth device establish the second Bluetooth connection, the second Bluetooth connection may serve as the physical link between the electronic device and the Bluetooth device. When the preset data is required to be transmitted based on the second Bluetooth connection, a logical channel for data transmission is required to be established based on the physical link. For example, for a classic Bluetooth mode, the electronic device and the Bluetooth device establish a classic Bluetooth link as the physical link between the electronic device and the Bluetooth device. The logical link may be established on this physical link, and the data transmission channel may be established based on the logical link. In some embodiments, the data transmission channel for the classic Bluetooth communication mode may be the aforementioned A2DP protocol and/or SCO link, while the data transmission channel for the LE Audio mode may be the aforementioned CIS audio transmission channel. Therefore, after the second Bluetooth connection is successfully established between the electronic device and the Bluetooth device and the data transmission channel is successfully established based on the second Bluetooth connection, the electronic device may send the preset data to the Bluetooth device via the data transmission channel.

It should be noted that for the second Bluetooth link, there may may multiple moments including a first moment, a second moment, and a third moment. The first moment is a moment when the second Bluetooth connection is successfully established between the electronic device and the Bluetooth device, a second moment is a moment when the electronic device begins performing the operation of establishing the data transmission channel based on the established second Bluetooth link, and a third moment is a moment when the data transmission channel is successfully established. It should be noted that each of the above moments may correspond to a preset time range of the exact time point when the corresponding event occurs. In other words, the above moments may be moments when the electronic device knows that the second Bluetooth link is successfully established, the operation of beginning establishing the data transmission channel begins being performed, and the data transmission channel being successfully established.

In some embodiments, in response to the designated request, in a case where the first Bluetooth connection is maintained, the preset data is transmitted continually via the first Bluetooth connection, and the second Bluetooth connection between the electronic device and the Bluetooth device is established. Then the first Bluetooth connection may be disconnected based on any of the aforementioned first moment, second moment, or third moment. The following describes the implementations for each scenario.

In the first implementation, the first Bluetooth connection may be disconnected at a moment, i.e., the first time when the electronic device determines that the second Bluetooth link has been successfully established between the electronic device and the Bluetooth device. In this embodiment, since the duration required to establish the data transmission channel may be relatively short, it is unnecessary to disconnecting the first Bluetooth connection after the data transmission channel is successfully established, the first Bluetooth connection may be disconnected after the second Bluetooth link between the electronic device and the Bluetooth device is successfully established.

For example, in a case where the electronic device does not need to transmit preset data via the second Bluetooth link, the first Bluetooth connection may be disconnected when it is determined that the second Bluetooth link is successfully established. For example, after the second Bluetooth connection is successfully established, whether the preset data is required to be transmitted via the second Bluetooth connection is detected. In a case where the preset data is required to be transmitted via the second Bluetooth connection, the data transmission channel is established on the second Bluetooth connection, and the first Bluetooth connection is disconnected. In a case where the preset data is not required to be transmitted via the second Bluetooth connection, the first Bluetooth connection is disconnected when the second Bluetooth connection is successfully established. The implementation of determining whether the preset data is required to be transmitted via the second Bluetooth connection may include determining the remaining transmission duration of the preset data. The implementation of determining the remaining transmission duration may include determining the current remaining data of the preset data that has not been transmitted and a duration required for the electronic device to send the remaining data to the Bluetooth device via the first Bluetooth connection, and the duration is called a remaining duration. The time interval between the first moment and the third moment serves as a preset duration, which represents the duration from successfully establishing the second Bluetooth connection to successfully establishing the data transmission channel of the second Bluetooth connection. When the remaining duration is shorter than or equal to the preset duration, it is determined that the preset data is not required to be transmitted via the second Bluetooth connection, i.e., when the data transmission channel of the second Bluetooth connection is successfully established, the preset data has been fully transmitted via the first Bluetooth connection. When the remaining duration is longer than the preset duration, it is determined that the preset data is required to be transmitted via the second Bluetooth connection.

In another example, after the designated request is received, whether the usage of the second Bluetooth connection established by the electronic device is to transmit preset data is determined. For example, the electronic device transmits preset data via the first Bluetooth connection, in this case, the transmission object of the first Bluetooth connection is the preset data. After the designated request is detected, the electronic device continues transmitting the preset data via the first Bluetooth connection, and whether the electronic device detects a data switch request before the second Bluetooth connection is successfully established is determined. The data switch request is configured to request switching the data transmitted between the electronic device and the Bluetooth device. In some embodiments, the input of the data switch request may be determined based on the electronic device detecting that a designed function is enabled. The designed function may be a function that does not transmit the preset data but other data. When the data switch request is detected, it may be determined that the data to be transmitted between the electronic device and the Bluetooth device has changed from the preset data to new data, i.e., target data. This indicates that the preset data is not transmitted via the second Bluetooth connection, so that switching the Bluetooth connection does not negatively affect the transmission of the preset data. Therefore, the first Bluetooth connection may be disconnected when the second Bluetooth connection is successfully established, and the electronic device may transmit the target data via the second Bluetooth connection. It should be noted that whether the data switch request is obtained within a preset period is detected, the preset period may be a duration from receiving the designated request to the first moment. In some embodiments, the designated request may include the data switch request, i.e., the designated request may be configured to indicate the establishment of the second Bluetooth connection between the electronic device and the Bluetooth device and trigger switching the data transmitted between the electronic device and the Bluetooth device.

For example, in a case where the first Bluetooth connection has been established between the electronic device and the Bluetooth device and the user uses the Bluetooth device to play a song, the electronic device transmits the song data to the Bluetooth device via the first Bluetooth connection. When the user triggers the voice call function of the electronic device to request real-time voice call via the Bluetooth device, the electronic device and the Bluetooth device intend to transmit the voice data generated during the call via the second Bluetooth connection. Therefore, the transmission objects of the first Bluetooth connection and the second Bluetooth connection are different, so that it may be determined that the preset data is not required to be transmitted via the second Bluetooth connection. Otherwise, in a case where the transmission objects of the first Bluetooth connection and the second Bluetooth connection are the same, it may be determined that the preset data is required to be transmitted via the second Bluetooth connection.

In the second implementation, the electronic device may disconnect the first Bluetooth connection at a moment, i.e., the second moment when the electronic device knows that the second Bluetooth link has been successfully established and performs the operation of establishing the data transmission channel based on the second Bluetooth connection. In this embodiment, since the duration required to establish the data transmission channel may be relatively short, it is unnecessary to disconnecting the first Bluetooth connection after the data transmission channel is successfully established, the first Bluetooth connection may be disconnected at the moment when the electronic device begins establishing the data transmission channel.

In the third implementation, the electronic device may disconnect the first Bluetooth connection at a moment, i.e., the third moment when the electronic device determines that the data transmission channel has been successfully established.

It should be noted that the second and third implementations may be performed in a case where it is determined that the electronic device needs to transmit the preset data via the second Bluetooth connection. For example, after the second Bluetooth connection is successfully established, it is detected whether the preset data is required to be transmitted via the second Bluetooth connection. When the preset data is required to be transmitted via the second Bluetooth connection, the data transmission channel is established on the second Bluetooth connection. When the data transmission channel is successfully established, the first Bluetooth connection is disconnected, or in a case where the data transmission channel has been established on the second Bluetooth connection, when it is determined that the preset data is transmitted via the data transmission channel corresponding to the second Bluetooth connection, the first Bluetooth connection is disconnected. When the preset data is required to continue being transmitted via the second Bluetooth connection, a designed portion of the preset data may be sent to the Bluetooth device via the data transmission channel, the designed portion of the preset data is the portion of the preset data that has not been transmitted when the first Bluetooth connection is disconnected.

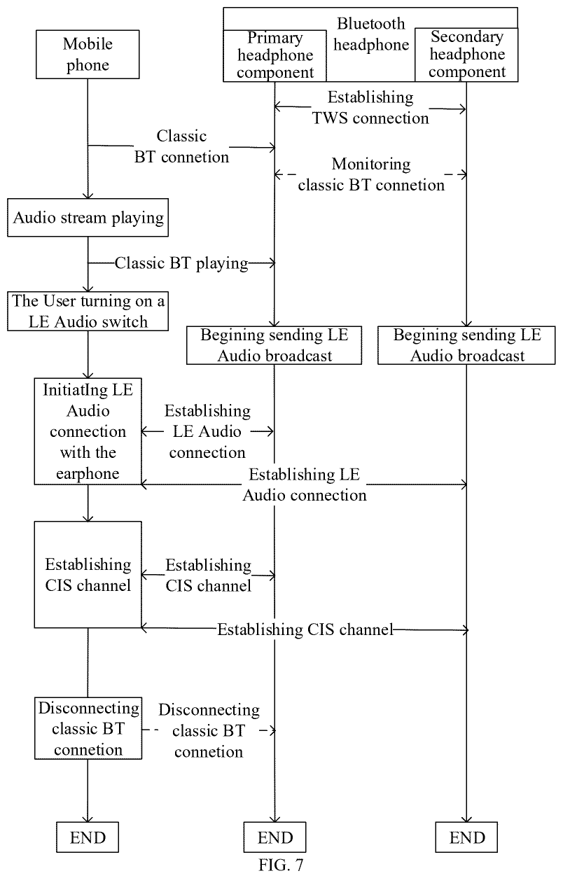

As shown in FIG. 7, it is assumed that the electronic device is a mobile phone, and the Bluetooth device is a Bluetooth headphone. In a case where the first Bluetooth connection is a classic Bluetooth connection and the classic Bluetooth connection has been established between the mobile phone and the Bluetooth headphone, an audio streaming operation is performed, i.e., the electronic device sends audio data to the Bluetooth headphone via the classic Bluetooth connection and the headphone plays the audio data. When the user turns on the LE Audio switch, the mobile phone may detect that the LE Audio switch is in the “on” state. For example, the LE Audio switch is the second switch 502 in the aforementioned interface. When the LE Audio switch is turned on, a first request is triggered, and the first request is configured to indicate the establishment of a LE Audio connection (i.e., the second Bluetooth connection) between the electronic device and the Bluetooth device. The mobile phone begins scanning the LE Audio broadcast sent by the headphone based on the designated request. The LE Audio broadcast includes the access address of the LE Audio mode of the headphone. For example, when the first request is triggered by the mobile phone, the mobile phone sends the first request to the headphone via the first Bluetooth connection. The headphone responds to the first request and begins sending the LE Audio broadcast. In some embodiments, the headphone may send the LE Audio broadcast based on the user triggering. For example, the user triggers the first request on the mobile phone, and the headphone is triggered by the user to send the LE Audio broadcast. In some embodiments, the first request may be triggered by the headphone. The headphone sends the LE Audio broadcast based on the first request and sends the first request to the mobile phone via the first Bluetooth connection. The mobile phone begins scanning the LE Audio broadcast and initiates a connection request after successfully receiving the LE Audio broadcast.

The headphone establishes the LE Audio connection with the headphone based on the LE Audio broadcast. It should be noted that the Bluetooth headphone includes a primary headphone component and a secondary headphone component. The mobile phone scans the LE Audio broadcast sent by the primary headphone component and the LE Audio broadcast sent by the secondary headphone component, respectively, and establishes a LE Audio connection with the primary headphone component and a LE Audio connection with the secondary headphone component. Then, the mobile phone disconnects the classic Bluetooth connection with the headphone (e.g., the primary headphone component). In this way, the Bluetooth connection between the mobile phone and the Bluetooth headphone is the LE Audio connection.

In some embodiments, the mobile phone establishes a CIS channel, i.e., the data transmission channel, based on the LE Audio connection. After the data transmission channel is successfully established, the mobile phone may continue transmitting the audio data corresponding to the aforementioned audio streaming playback operation via the CIS channel. Similarly, in a case where the Bluetooth connection between the mobile phone and the Bluetooth headphone is the LE Audio connection, when the LE Audio switch is switched to the “off” state, a second request is detected, the second request is configured to indicate the establishment of a classic Bluetooth connection between the electronic device and the Bluetooth device. Thus, the mobile phone establishes the classic Bluetooth connection between the electronic device and the Bluetooth headphone. For example, the mobile phone establishes the classic Bluetooth connection again.

Therefore, in some embodiments, in a case where the electronic device and the Bluetooth device are transmitting data via the first Bluetooth connection, and after a request to establish the second Bluetooth connection between the electronic device and the Bluetooth device is detect, the electronic device disconnects the first Bluetooth connection when it is determined that the second Bluetooth connection is successfully established, that the establishment of the data transmission channel begins, or that the data transmission channel has been successfully established. In this way, the negative impact of interrupted data transmission is reduced.

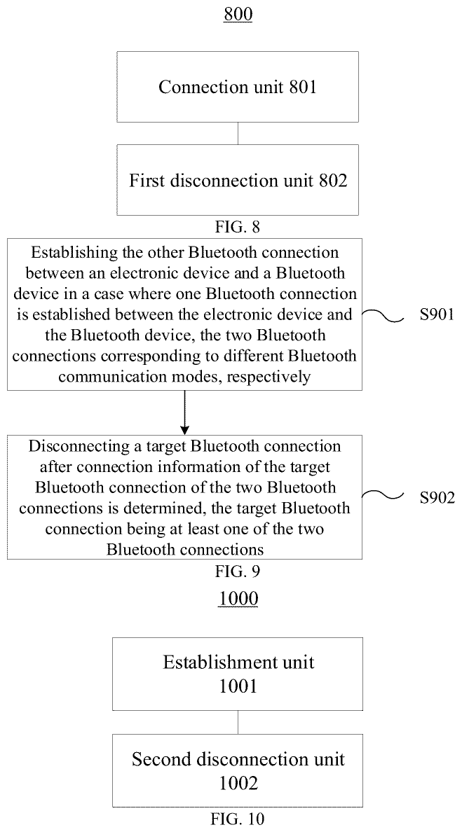

As shown in FIG. 8, FIG. 8 is a block diagram of an embodiment of a Bluetooth switching apparatus according to the present disclosure. The Bluetooth switching apparatus 800 may include a connection unit 801 and a first disconnection unit 802.

The connection unit 801 may be configured to establish a second Bluetooth connection between an electronic device and a Bluetooth device in the case where a first Bluetooth connection has been established between the electronic device and the Bluetooth device.

The first disconnection unit 802 may be configured to disconnect the first Bluetooth connection after the second Bluetooth connection is successfully established.

In some embodiments, the connection unit 801 may be configured to: in a case where the first Bluetooth connection has been established between the electronic device and the Bluetooth device, determine a designated request, and establish the second Bluetooth connection between the electronic device and the Bluetooth device in response to the designated request, and transmit the preset data between the electronic device and the Bluetooth device in a case where the first Bluetooth connection has been established between the electronic device and the Bluetooth device,. The connection unit 801 may be configured to: in a case where the first Bluetooth connection is maintained, in response to the designated request, continue transmitting the preset data via the first Bluetooth connection, and establish the second Bluetooth connection between the electronic device and the Bluetooth device.

In some embodiments, the connection unit 801 may be configured to: in a case where the first Bluetooth connection is maintained, in response to the designated request, scan a preset broadcast sent by the Bluetooth device, and establish the second Bluetooth connection between the electronic device and the Bluetooth device based on the preset broadcast.

In some embodiments, the first disconnection unit 802 may be configured to: after the second Bluetooth connection is successfully established, establish a data transmission channel on the second Bluetooth connection and disconnect the first Bluetooth connection. The data transmission channel may be configured to transmit the preset data.

In some embodiments, the first disconnection unit 802 may be configured to: after the second Bluetooth connection is successfully established, detect whether the preset data is required to be transmitted via the second Bluetooth connection; when the preset data is required to be transmitted via the second Bluetooth connection, establish the data transmission channel on the second Bluetooth connection and disconnect the first Bluetooth connection.

In some embodiments, in a case where preset data is not transmitted via the first Bluetooth connection, the first disconnection unit 802 may be configured to: disconnect the first Bluetooth connection after the second Bluetooth connection is successfully established but before the data transmission channel is established on the second Bluetooth connection.

In some embodiments, the first disconnection unit 802 may be configured to: in a case where the preset data is no required to be transmitted via the second Bluetooth connection, disconnect the first Bluetooth connection when the second Bluetooth connection is successfully established.

In some embodiments, the first disconnection unit 802 may be configured to: establish the data transmission channel on the second Bluetooth connection, and disconnect the first Bluetooth connection when the data transmission channel is successfully established.

In some embodiments, the first disconnection unit 802 may be configured to: in a case where the data transmission channel is successfully established, after disconnecting the first Bluetooth connection, send a designed portion of the preset data to the Bluetooth device via the data transmission channel. The designed portion of the preset data is the portion of the preset data that has not been transmitted when the first Bluetooth connection is disconnected.

As shown in FIG. 9, FIG. 9 illustrates a Bluetooth switching method according to some embodiments of the present disclosure. The Bluetooth connection method may be performed by an electronic device, a Bluetooth device, or a system including both an electronic device and a Bluetooth device. The Bluetooth connection method may include operations S901 to S902.

The operation S901 may include: establishing the other Bluetooth connection between an electronic device and a Bluetooth device in a case where one Bluetooth connection is established between the electronic device and the Bluetooth device, the two Bluetooth connections corresponding to different Bluetooth communication modes, respectively.

The operation S902 may include: disconnecting a target Bluetooth connection after connection information of the target Bluetooth connection of the two Bluetooth connections is determined, the target Bluetooth connection being at least one of the two Bluetooth connections.

In a case where one Bluetooth connection has been established between the electronic device and the Bluetooth device, the other Bluetooth connection is established between the electronic device and the Bluetooth device, the two Bluetooth connections correspond to different Bluetooth communication modes, respectively.

It should be understood that the electronic device and the Bluetooth device may support multi-mode Bluetooth, i.e., they may support different Bluetooth communication modes, such as a classic Bluetooth, a LE Audio Bluetooth, and other Bluetooth communication modes. For example, one of the two Bluetooth connections may be a classic Bluetooth connection, and the other Bluetooth connection may be a LE Audio Bluetooth connection.

It should be understood that the aforementioned connection process may occur during the initial connection between the electronic device and the Bluetooth device, e.g., during the headphone that the cover is opened for the first time pairing with the electronic device, or during the headphone that restores factory settings pairing with the mobile phone. The connection information such as a Bluetooth address and pairing information, etc., of the two Bluetooth connections may be obtained in the process of initial pairing via establishing two Bluetooth connections, facilitating subsequent Bluetooth connection.

In some embodiments, during the process of establishing one Bluetooth connection between the electronic device and the Bluetooth device, the other Bluetooth connection is established between the electronic device and the Bluetooth device. For example, in a case where the one Bluetooth connection is a classic Bluetooth connection, during the process of establishing the one Bluetooth connection between the electronic device and the Bluetooth device, the communication link (e.g., ACL) of the classic Bluetooth may be established. It should be understood that during the establishment of the one Bluetooth connection, the connection information of the other Bluetooth connection, such as the Bluetooth address, may be obtained, thereby speeding up the establishment of the other Bluetooth connection.

In some embodiments, after the one Bluetooth connection is established between the electronic device and the Bluetooth device, the other Bluetooth connection is established between the electronic device and the Bluetooth device. For example, after and an upper-layer transmission protocol based on the communication link is established to complete the Bluetooth connection, the other Bluetooth connection may be established.

In some embodiments, after the connection information of the target Bluetooth connection of the two Bluetooth connections is determined, the target Bluetooth connection is disconnected.

It should be understood that one of the two Bluetooth connections may serve as the target Bluetooth connection. For example, the LE Audio Bluetooth connection may serve as the target Bluetooth connection. The target Bluetooth connection may be preset before leaving the factory or set by the user. The target Bluetooth connection may indicates that in a case (such as during restoring factory settings or the first pairing) where there is no the connection information (such as Bluetooth address and pairing information, etc.), after obtaining the connection information of the target Bluetooth connection between the electronic device and the Bluetooth device via establishment of a Bluetooth connection, the electronic device needs to disconnect the Bluetooth connection.

It should be noted that there being no connection information may mean that the electronic device and/or the Bluetooth device have no connection information, such as pairing information, so that they are not capable of establishing a Bluetooth connection via reconnection and need to re-pair. In a case where there is no connection information, to ensure that subsequent use does not require re-pairing to improve the switching speed between the two Bluetooth connections and simplify user operations, the two Bluetooth connections may first be established to obtain corresponding connection information. Since the non-target Bluetooth connection is not disconnected by default after the initial connection, the connection information of the non-target Bluetooth connection is definitely obtained. For disconnection of the target Bluetooth connection, whether the connection information of the target Bluetooth connection is obtained is required to be considered, so that the target Bluetooth connection is disconnected after the connection information of the target Bluetooth connection is determined. Otherwise, the operation of establishing the target Bluetooth connection may make no sense. For example, the target Bluetooth connection may be disconnected immediately after the connection information of the target Bluetooth connection is determined; or the target Bluetooth connection may be disconnected after the target Bluetooth connection is successfully established; or the target Bluetooth connection may be disconnected when there is a playback service request, because maintaining both Bluetooth connections simultaneously during playback may negatively affect bandwidth and playback.

In some embodiments, the two Bluetooth connections include a first Bluetooth connection and a second Bluetooth connection. The second Bluetooth connection is the target Bluetooth connection, and the first and second Bluetooth connections correspond to different Bluetooth communication modes, respectively. For example, the first Bluetooth connection may correspond to a LE Audio Bluetooth connection, and the second Bluetooth connection may correspond to a classic Bluetooth connection.

In some embodiments, in a case where the second Bluetooth connection is established between the electronic device and the Bluetooth device, the first Bluetooth connection may be established between the electronic device and the Bluetooth device.

In some embodiments, to enable the connection information obtained via the initial establishment of the two Bluetooth connections to be used in subsequent connections, the electronic device and/or the Bluetooth device is required to store the first Bluetooth connection information of the first Bluetooth connection and the second Bluetooth connection information of the second Bluetooth connection.

In some embodiments, the operation of disconnecting the target Bluetooth connection after the connection information of the target Bluetooth connection of the two Bluetooth connections is determined may include:
disconnecting the second Bluetooth connection after the connection information of the second Bluetooth connection is determined; or
disconnecting the second Bluetooth connection after the connection information of both the first and second Bluetooth connections is determined; or
disconnecting the second Bluetooth connection after it is determined that the first Bluetooth connection is successfully established; or
disconnecting the second Bluetooth connection after it is determined that both the first and second Bluetooth connections are successfully established.

To simplify user operation, in some embodiments, in response to a user connection operation, the second Bluetooth connection is established between the electronic device and the Bluetooth device. In a case where the second Bluetooth connection between the electronic device and the Bluetooth device is established, the first Bluetooth connection is established between the electronic device and the Bluetooth device. That is, the user only needs to perform one operation to establish both Bluetooth connections, simplifying user operation. For example, the electronic device may obtain the LE Audio Bluetooth address (e.g., BLE address) of the Bluetooth device during the process of establishing a classic Bluetooth connection with the Bluetooth device. Then, when receiving a LE Audio Bluetooth broadcast having the LE Audio Bluetooth address, the electronic device may initiate a LE Audio Bluetooth connection with the Bluetooth device. Thus, during the initial establishment of the two Bluetooth connections, the user does not need to trigger the connection twice, a single trigger may achieve both connections. In some embodiments, a coordinated set identification profile (CSIP) in the Bluetooth standards may be configured to complete the connection of a group of Bluetooth devices. In some embodiments, other methods may complete the connection of a group of Bluetooth devices. In some embodiments, establishing the LE Audio Bluetooth connection first and then the classic Bluetooth connection falls within the scope of the present disclosure.

It should be noted that the user connection operation may be performed on the electronic device or the Bluetooth device. For example, the electronic device (e.g., a mobile phone, a tablet, a computer, or a TV, etc.) may have a Bluetooth display interface (e.g., a Bluetooth settings interface, a Bluetooth management app interface, or a connection pop-up interface). The user may select the clicking-connection button of a corresponding Bluetooth device in the Bluetooth display interface to trigger the Bluetooth connection. In a case where the Bluetooth device has a display, such as a visual speaker or TV, etc., the operation performed on the electronic device may be performed on the Bluetooth device. In a case where the Bluetooth device is a headphone, the Bluetooth device may provide feedback to the user via voice or other means, and the user may trigger the connection by operating controls on the headphone.

It should be understood that the aforementioned Bluetooth connection method may be combined with the technical features, technical solutions, or embodiments of the aforementioned Bluetooth switching method. In other words, the connection information of the two Bluetooth connections may first be obtained via the Bluetooth connection methods, and then one of the two Bluetooth connections may be maintained. During subsequent switching to the other Bluetooth connection, re-pairing is unnecessary, e.g., reconnection may be performed directly, thereby reducing the duration of establishing the other Bluetooth connection, improving switching speed, and simplifying user operation.

In some embodiments, after the second Bluetooth connection is disconnected, the Bluetooth connection method may include following operations (the following operations may be understood as the Bluetooth switching method).

In a case where the first Bluetooth connection has been established between the electronic device and the Bluetooth device, in response to a designated request, the second Bluetooth connection is established between the electronic device and the Bluetooth device and the first Bluetooth connection is maintained.

It should be understood that after the second Bluetooth connection is disconnected, the first Bluetooth connection is remained between the electronic device and the Bluetooth device. When Bluetooth communication mode is switched, e.g., the user wants to transmit audio data via the LE Audio Bluetooth protocol, the user may turn on the LE Audio switch displayed on the electronic device, and trigger the designated request. In response to the designated request, the second Bluetooth connection is established between the electronic device and the Bluetooth device while the first Bluetooth connection is maintained, thereby avoiding a situation where the first Bluetooth connection is disconnected and the second Bluetooth connection fails to be established, which could disrupt the user's experience of using the Bluetooth device.

It should be noted that the designated request may be generated on the electronic device or the Bluetooth device. For example, the user may touch a control on the Bluetooth device to generate the designated request. The designated request may refer to the description in the aforementioned Bluetooth switching method embodiments.

In some embodiments, after the communication link of the second Bluetooth connection is successfully established, the first Bluetooth connection is disconnected.

It should be understood that the communication link may include a physical link or a logical link. After the communication link is established, the probability of a successful connection increases. Therefore, the first Bluetooth connection may be disconnected after the communication link is established. For example, the following methods may be used.

In a first implementation, the first Bluetooth connection is disconnected after it is determined that the physical link of the second Bluetooth connection is established.

In a second implementation, the first Bluetooth connection is disconnected after it is determined that the logical link of the second Bluetooth connection is established. The logical link may be an ACL.

In a third implementation, the first Bluetooth connection is disconnected after it is determined that the audio transmission protocol of the second Bluetooth connection is established. It should be understood that when the second Bluetooth connection is a classic Bluetooth connection, the audio transmission protocol may be a A2DP protocol or a HFP protocol, etc. of the classic Bluetooth.

In a fourth implementation, the first Bluetooth connection is disconnected after it is determined that the audio transmission channel of the second Bluetooth connection is established. It should be understood that the audio transmission channel may be a SCO when the second Bluetooth connection is a classic Bluetooth connection, and the audio transmission channel may be a CIS when the second Bluetooth connection is a LE Audio Bluetooth connection.

In a fifth implementation, the first Bluetooth connection is disconnected after it is determined that audio data is transmitted via the second Bluetooth connection. It should be understood that the first Bluetooth connection may be disconnected after the audio data transmission has fully switched to the second Bluetooth connection, thereby reducing the interruption duration caused by switching the Bluetooth communication mode.

It should be noted that the performing subject of the aforementioned implementations may be the electronic device or the Bluetooth device. The definitions of ACL, SCO, CIS, A2DP, and HFP may refer to the relevant Bluetooth standard protocols. The aforementioned implementations may serve as feasible implementations for “the first Bluetooth connection is disconnected after the second Bluetooth connection is successfully established” in the aforementioned Bluetooth switching method.

In some embodiments, when no audio transmission service is performed (e.g., no playback service is required), any of the aforementioned implementations may be used for switching.

In some embodiments, in a case where the first Bluetooth connection is a LE Audio Bluetooth connection and the second Bluetooth connection is a classic Bluetooth connection, after the second Bluetooth connection is disconnected, the method may include operations.

In a case where the electronic device performs the first service, in response to the designed request, a second Bluetooth connection is established between the electronic device and the Bluetooth device when the first service is performed via the first Bluetooth connection.

Further, the first Bluetooth connection may be disconnected after it is determined that the first audio transmission protocol of the second Bluetooth connection is established. In some embodiments, the first Bluetooth connection may be disconnected after it is determined that the first service is performed based on the second Bluetooth connection.

It should be understood that the first service may be an audio playback service with high sound quality requirements, such as a music playback service, or an audio playback service with low real-time requirements, such as a voice message playback service. Since the connection information of the first and second Bluetooth connections has been stored, the second Bluetooth connection may be established directly via reconnection. In a classic Bluetooth, the first service does not require the establishment of an SCO audio transmission channel, and only the first audio transmission protocol (e.g., an A2DP protocol) is required to be established and then audio data is transmitted via the ACL. Therefore, in a case where a Bluetooth communication mode is switched during performing the first service, the first service may be first performed via the Bluetooth connection, and the first Bluetooth connection may be disconnected after the second Bluetooth connection is capable of transmitting audio data. In some embodiments, the first Bluetooth connection may be disconnected after the audio data of the first service has been transferred to the second Bluetooth connection for transmission, thereby further reducing the interruption duration caused by switching.

In some embodiments, in a case where the first Bluetooth connection is a LE Audio Bluetooth connection and the second Bluetooth connection is a classic Bluetooth connection, after the second Bluetooth connection is disconnected, the method may include: in a case where the electronic device performs a second service, in response to the designated request, establishing the second Bluetooth connection between the electronic device and the Bluetooth device when the second service is performed via the first Bluetooth connection.

It should be understood that the second service may be an audio service with high real-time requirements, such as a call service, a voice call service, or a video call service. In a classic Bluetooth, the second service requires the establishment of a second audio transmission channel (e.g., a SCO) for playback. Therefore, the following strategies may be used to disconnect the first Bluetooth connection:

In some embodiments, the first Bluetooth connection may be disconnected after it is determined that the second audio transmission protocol of the second Bluetooth connection is established. It should be understood that in classic Bluetooth, the second audio transmission protocol may be a HFP protocol. The first Bluetooth connection may be disconnected after the HFP protocol is established, thereby reducing the interruption duration to some extent and further triggering the establishment of a SCO channel.

For example, the first Bluetooth connection may be disconnected after it is determined that the first audio transmission channel of the second Bluetooth connection is established. It should be understood that since the second service is required to be transmitted on the SCO channel of the classic Bluetooth connection, disconnecting the first Bluetooth connection after the SCO channel is established may further reduce the interruption duration caused by switching the Bluetooth communication mode.

In some embodiments, the first Bluetooth connection may be disconnected after it is determined that the second service is performed based on the second Bluetooth connection. It should be understood that the first Bluetooth connection may be disconnected after the SCO channel of the classic Bluetooth connection is successfully established and the audio data of the second service has been transferred from the first Bluetooth connection to the second Bluetooth connection for transmission, thereby further reducing the aforementioned interruption duration.

It should be understood that when a LE Audio Bluetooth connection is switched to a classic Bluetooth connection, the electronic device may directly page to be reconnected to the Bluetooth device, or the Bluetooth device may directly page to be reconnected to the electronic device.

In some embodiments, in a case where the first Bluetooth connection is a classic Bluetooth connection and the second Bluetooth connection is a LE Audio Bluetooth connection, after the second Bluetooth connection is disconnected, the method may include: in the case where the electronic device performs a third service, in response to the designated request, establishing the second Bluetooth connection between the electronic device and the Bluetooth device when the third service is performed via the first Bluetooth connection.

The first Bluetooth connection may be disconnected after it is determined that the second audio transmission channel of the second Bluetooth connection is established; or the first Bluetooth connection may be disconnected after it is determined that the third service is performed based on the second Bluetooth connection.

It should be understood that since audio transmission in the LE Audio Bluetooth is required to be performed based on the CIS channel or the BIS channel, the third service may be an audio transmission service, including the service scenarios mentioned in the first and second services. In this embodiment, the second audio transmission channel may be the CIS channel or the BIS channel. After the second audio transmission channel is established, the first Bluetooth connection may be disconnected after the audio transmission data of the third service has been transferred to the second Bluetooth connection for transmission, thereby further reducing the interruption duration of audio playback caused by switching the Bluetooth communication mode.

It should be noted that in some embodiments, the first, second, and third services may correspond to the preset data in the aforementioned Bluetooth switching method embodiments.

In some embodiments, in a case where the second Bluetooth connection is a LE Audio Bluetooth connection, to reduce power consumption, the Bluetooth device may begin sending the LE Audio Bluetooth broadcast after receiving the designated request. When the user triggers the enabling of the LE Audio on the electronic device, the electronic device may send an indication (e.g., the designated request or another indication) to the Bluetooth device via the first Bluetooth connection to trigger the Bluetooth device to start sending the LE Audio Bluetooth broadcast. The electronic device initiates a request of establishing the LE Audio Bluetooth connection after receiving the LE Audio Bluetooth broadcast, and establishes the LE Audio Bluetooth connection. During the establishment of the second Bluetooth connection, the first Bluetooth connection continues performing the first service, thereby reducing the switching duration perceived by the user and improving the user experience.

It should be noted that the technical features in the aforementioned embodiments may be cross-referenced and combined with each other without conflict. For example, the relevant embodiments, implementations, and relevant technical features of the Bluetooth switching method and the Bluetooth connection method may be cross-referenced, interpreted, and combined with each other. Some technical features and professional terms, such as the methods for establishing Bluetooth connections, may refer to the relevant Bluetooth standards and may change as these standards evolve, which are not repeated here. As shown in FIG. 10, FIG. 10 is a block diagram of an embodiment of a Bluetooth switching apparatus according to the present disclosure. The Bluetooth switching apparatus 1000 may include an establishment unit 1001 and a second disconnection unit 1002.

The establishment unit 1001 may be configured to establish the other Bluetooth connection between an electronic device and a Bluetooth device in the case where one Bluetooth connection has been established between the electronic device and the Bluetooth device. The two Bluetooth connections correspond to different Bluetooth communication modes, respectively.

The second disconnection unit 1002 is configured to disconnect a target Bluetooth connection after connection information of the target Bluetooth connection of the two Bluetooth connections is determined. The target Bluetooth connection is at least one of the two Bluetooth connections.

In some embodiments, the two Bluetooth connections include a first Bluetooth connection and a second Bluetooth connection. The second Bluetooth connection is the target Bluetooth connection, and the first and second Bluetooth connections correspond to different Bluetooth communication modes, respectively. The establishment unit 1001 may be configured to establish the first Bluetooth connection between the electronic device and the Bluetooth device in a case where the second Bluetooth connection is established between the electronic device and the Bluetooth device. The second disconnection unit 1002 may be configured to disconnect the second Bluetooth connection after the connection information of the second Bluetooth connection is determined. In some embodiments, the second Bluetooth connection may be disconnected after connection information of the first Bluetooth connection and the connection information of the second Bluetooth connection are determined; In some embodiments, the second Bluetooth connection may be disconnected after it is determined that the first Bluetooth connection is successfully established. In some embodiments, the second Bluetooth connection may be disconnected after it is determined that both the first and second Bluetooth connections are successfully established.

In some embodiments, the second disconnection unit 1002 may be configured to store the first Bluetooth connection information of the first Bluetooth connection and the second Bluetooth connection information of the second Bluetooth connection after the second Bluetooth connection is disconnected.

In some embodiments, the establishment unit 1001 may be configured to establish the second Bluetooth connection between the electronic device and the Bluetooth device in response to a connection operation, and establish the first Bluetooth connection between the electronic device and the Bluetooth device in a case where the second Bluetooth connection is established between the electronic device and the Bluetooth device. In some embodiments, the second disconnection unit 1002 is may be configured to: after the second Bluetooth connection is disconnected, in a case where the first Bluetooth connection is established between the electronic device and the Bluetooth device, establish the second Bluetooth connection between the electronic device and the Bluetooth device and maintain the first Bluetooth connection, and disconnect the first Bluetooth connection after the communication link of the second Bluetooth connection is successfully established. For example, the communication link may include a physical link or a logical link, etc. For example, the second disconnection unit 1002 may be configured to disconnect the first Bluetooth connection after it is determined that the physical link of the second Bluetooth connection is established, or the second disconnection unit 1002 may be configured to disconnect the first Bluetooth connection after it is determined that the logical link of the second Bluetooth connection is established, or the second disconnection unit 1002 may be configured to disconnect the first Bluetooth connection after it is determined that the audio transmission protocol of the second Bluetooth connection is established, or the second disconnection unit 1002 may be configured to disconnect the first Bluetooth connection after it is determined that the audio transmission channel of the second Bluetooth connection is established, or the second disconnection unit 1002 may be configured to disconnect the first Bluetooth connection after it is determined that audio data is transmitted via the second Bluetooth connection.

In some embodiments, the first Bluetooth connection is a LE Audio Bluetooth connection and the second Bluetooth connection is a classic Bluetooth connection. The second disconnection unit 1002 may be configured to: after the second Bluetooth connection is disconnected, in a case where the first service is performed via the first Bluetooth connection, establish the second Bluetooth connection between the electronic device and the Bluetooth device; and disconnect the first Bluetooth connection after it is determined that the first audio transmission protocol of the second Bluetooth connection is established, or disconnect the first Bluetooth connection after it is determined that the first service is performed based on the second Bluetooth connection. For example, the first service may include a music playback service or a voice message playback service.

In some embodiments, the first Bluetooth connection is a LE Audio Bluetooth connection and the second Bluetooth connection is a classic Bluetooth connection. The second disconnection unit 1002 may be configured to: establish the second Bluetooth connection between the electronic device and the Bluetooth device in a case where the second service is performed via the first Bluetooth connection, and disconnect the first Bluetooth connection after it is determined that the second audio transmission protocol of the second Bluetooth connection is established, or disconnect the first Bluetooth connection after it is determined that the first audio transmission channel of the second Bluetooth connection is established, or disconnect the first Bluetooth connection after it is determined that the second service is performed based on the second Bluetooth connection. For example, the second service may include a call service, a voice call service, or a video call service.

In some embodiments, the first Bluetooth connection is a classic Bluetooth connection and the second Bluetooth connection is a LE Audio Bluetooth connection. The second disconnection unit 1002 may be configured to: after the second Bluetooth connection is disconnected, establish the second Bluetooth connection between the electronic device and the Bluetooth device in a case where the third service is performed via the first Bluetooth connection, and disconnect the first Bluetooth connection after it is determined that the second audio transmission channel of the second Bluetooth connection is established, or disconnect the first Bluetooth connection after it is determined that the third service is performed based on the second Bluetooth connection.

Those skilled in the art may clearly understand that, for the convenience and brevity of description, the working processes of the aforementioned apparatus and modules may refer to the corresponding processes in the aforementioned method embodiments and are not repeated here.

In some embodiments provided in the present disclosure, the coupling between modules may be electrical, mechanical, or of other forms.

In addition, the various functional modules in the various embodiments of the present disclosure may be integrated into one processing module, or each module may exist physically alone, or two or more modules may be integrated into one module. The integrated modules may be implemented in a form of hardware or software functional modules.

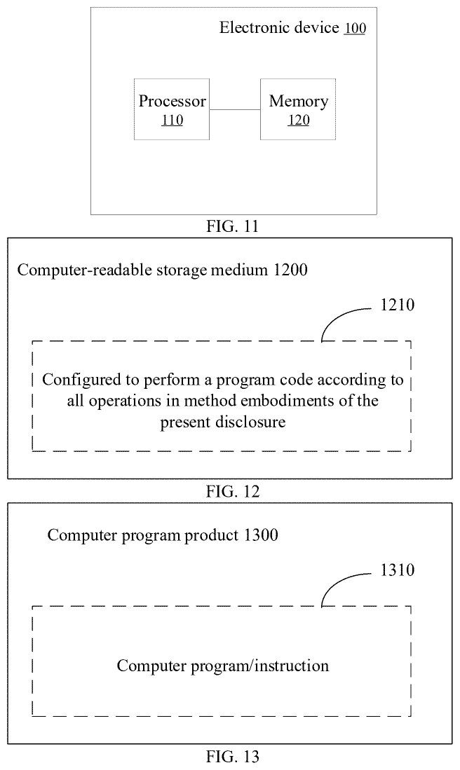

As shown in FIG. 11, FIG. 11 is a block diagram of a structure of an electronic device according to an embodiment of the present disclosure. The electronic device 100 may be a smartphone, a tablet, an e-reader, or other electronic device capable of running applications. The electronic device 100 in some embodiments of the present disclosure may include one or more of the following components: a processor 110, a memory 120, and one or more applications. The one or more applications may be stored in the memory 120, and configured to be executed by the one or more processors, and configured to implement the methods described in the aforementioned method embodiments.

The processor 110 may include one or more processing cores. The processor 110 may be connected to various parts of the entire Bluetooth device 100 through various interfaces and circuits, and execute various functions and process data of the Bluetooth device 100 by running or executing instructions, programs, code sets, or instruction sets stored in the memory 120, and by invoking data stored in the memory 120. In some embodiments, the processor 110 may be implemented in least one hardware form including: a Digital Signal Processing (DSP), a Field-Programmable Gate Array (FPGA), or a Programmable Logic Array (PLA). The processor 110 may integrate one or more of a Central Processing Unit (CPU), a Graphics Processing Unit (GPU), and a modem. The CPU mainly processes an operating system, a user interface, and an application. The GPU is responsible for rendering and drawing display content. The modem is responsible for processing wireless communication. It may be understood that the above modem may not be integrated into the processor 110 but implemented separately through a communication chip.

The memory 120 may include a Random Access Memory (RAM) and a Read-Only Memory (ROM). The memory 120 may be configured to store instructions, programs, code, code sets, or instruction sets. The memory 120 may include a program storage area and a data storage area. The program storage area may store instructions for implementing the operating system, instructions for implementing at least one function (such as a touch function, a sound playback function, and image playback function, etc.), and instructions for implementing the following method embodiments. The data storage area may store data (e.g., phone book, audio and video data, chat record data) created during the use of the terminal 100.

As shown in FIG. 12, FIG. 12 is a block diagram of a computer-readable storage medium according to an embodiment of the present disclosure. The computer-readable medium 1200 stores a program code that may be called by a processor to perform the methods described in the aforementioned method embodiments.

The computer-readable storage medium 1200 may be an electronic memory such as a flash memory, an electrically erasable programmable read-only memory (EEPROM), an EPROM, a hard disk, or a ROM, etc. In some embodiments, the computer-readable storage medium 1200 may include a non-transitory computer-readable storage medium. The computer-readable storage medium 1200 has storage space for a program code 1210 that perform any operation in the aforementioned methods. The program code may be read from or written to one or more computer program products. The program code 1210 may be compressed, for example, in an appropriate form.

As shown in FIG. 13, FIG. 13 is a block diagram of a computer program product according to an embodiment of the present disclosure. The computer program product 1300 may include a computer program/instruction 1310. The computer program/instruction 1310, when is executed by a processor, implements the operations of the aforementioned methods.

In summary, in some embodiments of the present disclosure, in a case where the first Bluetooth connection has been established between the electronic device and the Bluetooth device, when the designated request configured to indicate the establishment of the second Bluetooth connection between the electronic device and the Bluetooth device is detected, in response to the designated request, the second Bluetooth connection is established between the electronic device and the Bluetooth device and the first Bluetooth connection is maintained. After the second Bluetooth connection is successfully established, the first Bluetooth connection is disconnected. Therefore, before the first Bluetooth connection is disconnected, it is ensured that the second Bluetooth connection is successfully established, avoiding a situation where the electronic device and the Bluetooth device cannot communicate normally via Bluetooth due to the second Bluetooth connection not being successfully established when the first Bluetooth connection is disconnected, and avoiding prolonged waiting duration of the user caused by prolonged establishment of the second Bluetooth connection when the electronic device and the Bluetooth device cannot communicate via Bluetooth.

For a scenario without a playback service, a target mode is connected first before the current mode is disconnected, e.g., to switch from a classic Bluetooth to a BLE Audio, the BLE Audio is connected first before the classic Bluetooth is disconnected. This ensures that at least one mode remains connected during the mode switch on the mobile phone, preventing a situation where the current mode is disconnected but the target mode fails to be connected, which causing no Bluetooth connection between the mobile phone and headphone and user inconvenience. This ensures the stability of the connection and switching process.

For a scenario with a playback service, a target mode is connected first, and a audio transmission channel of the target mode is established before the current mode is disconnected, e.g., when the user transmits data via a classic Bluetooth and switches to BLE Audio, the mobile phone is first connected to the headphone via the BLE Audio and establishes a CIS audio transmission channel with the headphone before stopping audio transmission via the classic Bluetooth and disconnecting the classic Bluetooth connection. By first connecting to the target mode and establishing the audio transmission channel of the target mode before disconnecting the current mode, the user's current usage is completely unaffected when the audio transmission channel of the target mode has not been established during the switching process. The mode is switched after the target mode is connected, and the entire switching duration is short, without prolonged silence or audio playing through the mobile phone's speaker, giving the user the impression of a fast and natural transition. In addition, this method avoids a situation where the target mode fails to be connected to cause audio to play through the mobile phone's speaker, thereby improving the overall experience of switching between the classic Bluetooth and the LE Audio for the TWS headphone and the mobile phone.

Some embodiments of the present disclosure provide a Bluetooth switching method performed by an electronic device and/or a Bluetooth device. The method includes: establishing a second Bluetooth connection between the electronic device and the Bluetooth device in a case where a first Bluetooth connection has been established between the electronic device and the Bluetooth device; and disconnecting the first Bluetooth connection after the second Bluetooth connection is successfully established.

In some embodiments, in a case where preset data is transmitted via the first Bluetooth connection, the establishing a second Bluetooth connection between the electronic device and the Bluetooth device, includes: continuing transmitting the preset data via the first Bluetooth connection, and establishing the second Bluetooth connection between the electronic device and the Bluetooth device.

In some embodiments, the disconnecting the first Bluetooth connection after the second Bluetooth connection is successfully established, includes: disconnecting the first Bluetooth connection after the second Bluetooth connection is successfully established and a data transmission channel is established on the second Bluetooth connection, the data transmission channel being configured to transmit preset data.

In some embodiments, in a case where preset data is not transmitted via the first Bluetooth connection, the disconnecting the first Bluetooth connection after the second Bluetooth connection is successfully established, includes: disconnecting the first Bluetooth connection after the second Bluetooth connection is successfully established and before a data transmission channel is established on the second Bluetooth connection.

In some embodiments, the establishing a second Bluetooth connection between the electronic device and the Bluetooth device in a case where a first Bluetooth connection has been established between the electronic device and the Bluetooth device, includes: determining a designated request in a case where the first Bluetooth connection has been established between the electronic device and the Bluetooth device; and establishing the second Bluetooth connection between the electronic device and the Bluetooth device in response to the designated request.

In some embodiments, the preset data is audio data, and the data transmission channel is an audio transmission channel.

In some embodiments, the establishing a second Bluetooth connection between the electronic device and the Bluetooth device, includes: scanning a preset broadcast sent by the Bluetooth device in a case where the first Bluetooth connection is maintained; and establishing the second Bluetooth connection between the electronic device and the Bluetooth device based on the preset broadcast.

In some embodiments, a Bluetooth mode of one of the first Bluetooth connection and the second Bluetooth connection is a classic Bluetooth mode, and a Bluetooth mode of the other Bluetooth connection of the first Bluetooth connection and the second Bluetooth connection is a low-energy audio Bluetooth mode.

Some embodiments of the present disclosure provide a Bluetooth connection method performed by an electronic device and/or a Bluetooth device. The method includes: establishing the other Bluetooth connection between the electronic device and the Bluetooth device in the case where one Bluetooth connection has been established between the electronic device and the Bluetooth device, the two Bluetooth connections correspond to different Bluetooth communication modes, respectively; and disconnecting a target Bluetooth connection after connection information of the target Bluetooth connection of the two Bluetooth connections is determined, the target Bluetooth connection being at least one of the two Bluetooth connections.

In some embodiments, the two Bluetooth connections include a first Bluetooth connection and a second Bluetooth connection, the second Bluetooth connection is the target Bluetooth connection, and the first Bluetooth connection and the second Bluetooth connection correspond to different Bluetooth communication modes, respectively; the establishing the other Bluetooth connection between the electronic device and the Bluetooth device in the case where one Bluetooth connection has been established between the electronic device and the Bluetooth device, includes: establishing the first Bluetooth connection between the electronic device and the Bluetooth device in a case where the second Bluetooth connection has been established between the electronic device and the Bluetooth device; the disconnecting a target Bluetooth connection after connection information of the target Bluetooth connection of the two Bluetooth connections is determined, includes: disconnecting the second Bluetooth connection after connection information of the second Bluetooth connection is determined; or disconnecting the second Bluetooth connection after connection information of the first Bluetooth connection and the connection information of the second Bluetooth connection are determined; or disconnecting the second Bluetooth connection after it is determined that the first Bluetooth connection is successfully established; or disconnecting the second Bluetooth connection after it is determined that both the first Bluetooth connection and the second Bluetooth connection are successfully established.

In some embodiments, after the disconnecting the second Bluetooth connection, the method further includes: storing the connection information of the first Bluetooth connection and the connection information of the second Bluetooth connection.

In some embodiments, the establishing the first Bluetooth connection between the electronic device and the Bluetooth device in a case where the second Bluetooth connection has been established between the electronic device and the Bluetooth device, includes: establishing the second Bluetooth connection between the electronic device and the Bluetooth device in response to a connection operation; and establishing the first Bluetooth connection between the electronic device and the Bluetooth device in a case where the second Bluetooth connection has been established between the electronic device and the Bluetooth device.

In some embodiments, after the disconnecting the second Bluetooth connection, the method further includes: in a case where the first Bluetooth connection has been established between the electronic device and the Bluetooth device, establishing the second Bluetooth connection between the electronic device and the Bluetooth device, and maintaining the first Bluetooth connection; and disconnecting the first Bluetooth connection after a communication link of the second Bluetooth connection is successfully established.

In some embodiments, the disconnecting the first Bluetooth connection after a communication link of the second Bluetooth connection is successfully established, includes: disconnecting the first Bluetooth connection after it is determined that a physical link of the second Bluetooth connection is established; or disconnecting the first Bluetooth connection after it is determined that a logical link of the second Bluetooth connection is established; or disconnecting the first Bluetooth connection after it is determined that an audio transmission protocol of the second Bluetooth connection is established; or disconnecting the first Bluetooth connection after it is determined that an audio transmission channel of the second Bluetooth connection is established; or disconnecting the first Bluetooth connection after it is determined that audio data is transmitted via the second Bluetooth connection.

In some embodiments, the first Bluetooth connection is a low-energy audio (LE Audio) Bluetooth connection, and the second Bluetooth connection is a classic Bluetooth connection; after the disconnecting the second Bluetooth connection, the method further includes: establishing the second Bluetooth connection between the electronic device and the Bluetooth device in a case where a first service is performed via the first Bluetooth connection; and disconnecting the first Bluetooth connection after it is determined that a first audio transmission protocol of the second Bluetooth connection is established; or disconnecting the first Bluetooth connection after it is determined that the first service is performed based on the second Bluetooth connection.

In some embodiments, the first service includes a music playback service or a voice message playback service.

In some embodiments, the first Bluetooth connection is a low-energy audio (LE Audio) Bluetooth connection, and the second Bluetooth connection is a classic Bluetooth connection; after the disconnecting the second Bluetooth connection, the method further includes: establishing the second Bluetooth connection between the electronic device and the Bluetooth device in a case where a second service is performed via the first Bluetooth connection; and disconnecting the first Bluetooth connection after it is determined that a second audio transmission protocol of the second Bluetooth connection is established; or disconnecting the first Bluetooth connection after it is determined that a first audio transmission channel of the second Bluetooth connection is established; or disconnecting the first Bluetooth connection after it is determined that the second service is performed based on the second Bluetooth connection.

In some embodiments, the second service includes a call service, a voice call service, or a video call service.

In some embodiments, the first Bluetooth connection is a classic Bluetooth connection, and the second Bluetooth connection is a low-energy audio (LE Audio) Bluetooth connection; after the disconnecting the second Bluetooth connection, the method further includes: establishing the second Bluetooth connection between the electronic device and the Bluetooth device in a case where a third service is performed via the first Bluetooth connection; and disconnecting the first Bluetooth connection after it is determined that a second audio transmission channel of the second Bluetooth connection is established; or disconnecting the first Bluetooth connection after it is determined that the third service is performed based on the second Bluetooth connection.

Some embodiments of the present disclosure provide a Bluetooth switching apparatus arranged in an electronic device and/or a Bluetooth device. The apparatus includes a connection unit and a first disconnection unit. The connection unit is configured to establish a second Bluetooth connection between the electronic device and the Bluetooth device in a case where a first Bluetooth connection has been established between the electronic device and the Bluetooth device, and the first disconnection unit, configured to disconnect the first Bluetooth connection after the second Bluetooth connection is successfully established.

Some embodiments of the present disclosure provide a Bluetooth connection apparatus arranged in an electronic device and/or a Bluetooth device. The apparatus includes an establishment unit and a second disconnection unit. The establishment unit is configured to establish the other Bluetooth connection between the electronic device and the Bluetooth device in a case where one Bluetooth connection has been established between the electronic device and the Bluetooth device, and the two Bluetooth connections correspond to different Bluetooth communication modes, respectively. The second disconnection unit is configured to disconnect a target Bluetooth connection after connection information of the target Bluetooth connection of the two Bluetooth connections is determined, and the target Bluetooth connection is at least one of the two Bluetooth connections.

Some embodiments of the present disclosure provide an electronic device. The electronic device includes one or more processors, a memory, and one or more application programs. The one or more application programs stored in the memory and configured to be executed by the one or more processors to cause the electronic device to implement any one of the above methods.

Some embodiments of the present disclosure provide a computer-readable medium storing a program code which is executable in a processor. The program code, when executed by the processor, implements any one of the above methods.

Finally, it should be noted that the above embodiments are only used to illustrate the technical solutions of the present disclosure and are not intended to limit the present disclosure. Although the present disclosure has been described in detail with reference to the aforementioned embodiments, those skilled in the art should understand that they may still modify the technical solutions described in the aforementioned embodiments or replace some technical features with equivalents. These modifications or replacements do not cause the essence of the corresponding technical solutions to deviate from the spirit and scope of the technical solutions of the embodiments of the present disclosure.

1. A Bluetooth switching method, performed by an electronic device and/or a Bluetooth device, and the method comprising:
establishing a second Bluetooth connection between the electronic device and the Bluetooth device in a case where a first Bluetooth connection has been established between the electronic device and the Bluetooth device; and
disconnecting the first Bluetooth connection after the second Bluetooth connection is successfully established.

2. The method as claimed in claim 1, wherein in a case where preset data is transmitted via the first Bluetooth connection, the establishing a second Bluetooth connection between the electronic device and the Bluetooth device, comprises:
continuing transmitting the preset data via the first Bluetooth connection, and establishing the second Bluetooth connection between the electronic device and the Bluetooth device.

3. The method as claimed in claim 1, wherein the disconnecting the first Bluetooth connection after the second Bluetooth connection is successfully established, comprises:
disconnecting the first Bluetooth connection after the second Bluetooth connection is successfully established and a data transmission channel is established on the second Bluetooth connection, the data transmission channel being configured to transmit preset data.

4. The method as claimed in claim 1, wherein in a case where preset data is not transmitted via the first Bluetooth connection, the disconnecting the first Bluetooth connection after the second Bluetooth connection is successfully established, comprises:
disconnecting the first Bluetooth connection after the second Bluetooth connection is successfully established and before a data transmission channel is established on the second Bluetooth connection.

5. The method as claimed in claim 1, wherein the establishing a second Bluetooth connection between the electronic device and the Bluetooth device in a case where a first Bluetooth connection has been established between the electronic device and the Bluetooth device, comprises:
determining a designated request in a case where the first Bluetooth connection has been established between the electronic device and the Bluetooth device; and
establishing the second Bluetooth connection between the electronic device and the Bluetooth device in response to the designated request.

6. The method as claimed in claim 3, wherein the preset data is audio data, and the data transmission channel is an audio transmission channel.

7. The method as claimed in claim 1, wherein the establishing a second Bluetooth connection between the electronic device and the Bluetooth device, comprises:
scanning a preset broadcast sent by the Bluetooth device in a case where the first Bluetooth connection is maintained; and
establishing the second Bluetooth connection between the electronic device and the Bluetooth device based on the preset broadcast.

8. The method as claimed in claim 1, wherein a Bluetooth mode of one of the first Bluetooth connection and the second Bluetooth connection is a classic Bluetooth mode, and a Bluetooth mode of the other Bluetooth connection of the first Bluetooth connection and the second Bluetooth connection is a low-energy audio Bluetooth mode.

9. A Bluetooth connection method, performed by an electronic device and/or a Bluetooth device, and the method comprising:
establishing the other Bluetooth connection between the electronic device and the Bluetooth device in the case where one Bluetooth connection has been established between the electronic device and the Bluetooth device, the two Bluetooth connections correspond to different Bluetooth communication modes, respectively; and
disconnecting a target Bluetooth connection after obtaining connection information of the target Bluetooth connection of the two Bluetooth connections, the target Bluetooth connection being at least one of the two Bluetooth connections.

10. The method as claimed in claim 9, wherein the two Bluetooth connections comprise a first Bluetooth connection and a second Bluetooth connection, the second Bluetooth connection is the target Bluetooth connection, and the first Bluetooth connection and the second Bluetooth connection correspond to different Bluetooth communication modes, respectively;
the establishing the other Bluetooth connection between the electronic device and the Bluetooth device in the case where one Bluetooth connection has been established between the electronic device and the Bluetooth device, comprises:
establishing the first Bluetooth connection between the electronic device and the Bluetooth device in a case where the second Bluetooth connection has been established between the electronic device and the Bluetooth device;
the disconnecting a target Bluetooth connection after connection information of the target Bluetooth connection of the two Bluetooth connections is determined, comprises:
disconnecting the second Bluetooth connection after obtaining connection information of the second Bluetooth connection; or
disconnecting the second Bluetooth connection after connection information of the first Bluetooth connection and the connection information of the second Bluetooth connection are determined; or
disconnecting the second Bluetooth connection after it is determined that the first Bluetooth connection is successfully established; or
disconnecting the second Bluetooth connection after it is determined that both the first Bluetooth connection and the second Bluetooth connection are successfully established.

11. The method as claimed in claim 10, after the disconnecting the second Bluetooth connection, the method further comprising:
storing the connection information of the first Bluetooth connection and the connection information of the second Bluetooth connection.

12. The method as claimed in claim 10, wherein the establishing the first Bluetooth connection between the electronic device and the Bluetooth device in a case where the second Bluetooth connection has been established between the electronic device and the Bluetooth device, comprises:
establishing the second Bluetooth connection between the electronic device and the Bluetooth device in response to a connection operation; and
establishing the first Bluetooth connection between the electronic device and the Bluetooth device in a case where the second Bluetooth connection has been established between the electronic device and the Bluetooth device.

13. The method as claimed in claim 10, after the disconnecting the second Bluetooth connection, the method further comprising:
in a case where the first Bluetooth connection has been established between the electronic device and the Bluetooth device, establishing the second Bluetooth connection between the electronic device and the Bluetooth device, and maintaining the first Bluetooth connection; and
disconnecting the first Bluetooth connection after a communication link of the second Bluetooth connection is successfully established.

14. The method as claimed in claim 13, wherein the disconnecting the first Bluetooth connection after a communication link of the second Bluetooth connection is successfully established, comprises:
disconnecting the first Bluetooth connection after it is determined that a physical link of the second Bluetooth connection is established; or
disconnecting the first Bluetooth connection after it is determined that a logical link of the second Bluetooth connection is established; or
disconnecting the first Bluetooth connection after it is determined that an audio transmission protocol of the second Bluetooth connection is established; or
disconnecting the first Bluetooth connection after it is determined that an audio transmission channel of the second Bluetooth connection is established; or
disconnecting the first Bluetooth connection after it is determined that audio data is transmitted via the second Bluetooth connection.

15. The method as claimed in claim 10, wherein the first Bluetooth connection is a low-energy audio (LE Audio) Bluetooth connection, and the second Bluetooth connection is a classic Bluetooth connection; after the disconnecting the second Bluetooth connection, the method further comprises:
establishing the second Bluetooth connection between the electronic device and the Bluetooth device in a case where a first service is performed via the first Bluetooth connection; and
disconnecting the first Bluetooth connection after it is determined that a first audio transmission protocol of the second Bluetooth connection is established; or
disconnecting the first Bluetooth connection after it is determined that the first service is performed based on the second Bluetooth connection;
wherein the first service comprises a music playback service or a voice message playback service.

16. (canceled)

17. The method as claimed in claim 10, wherein the first Bluetooth connection is a low-energy audio (LE Audio) Bluetooth connection, and the second Bluetooth connection is a classic Bluetooth connection; after the disconnecting the second Bluetooth connection, the method further comprises:
establishing the second Bluetooth connection between the electronic device and the Bluetooth device in a case where a second service is performed via the first Bluetooth connection; and
disconnecting the first Bluetooth connection after it is determined that a second audio transmission protocol of the second Bluetooth connection is established; or
disconnecting the first Bluetooth connection after it is determined that a first audio transmission channel of the second Bluetooth connection is established; or
disconnecting the first Bluetooth connection after it is determined that the second service is performed based on the second Bluetooth connection;
wherein the second service comprises a call service, a voice call service, or a video call service.

18. (canceled)

19. The method as claimed in claim 10, wherein the first Bluetooth connection is a classic Bluetooth connection, and the second Bluetooth connection is a low-energy audio (LE Audio) Bluetooth connection; after the disconnecting the second Bluetooth connection, the method further comprises:
establishing the second Bluetooth connection between the electronic device and the Bluetooth device in a case where a third service is performed via the first Bluetooth connection; and
disconnecting the first Bluetooth connection after it is determined that a second audio transmission channel of the second Bluetooth connection is established; or
disconnecting the first Bluetooth connection after it is determined that the third service is performed based on the second Bluetooth connection.

20-21. (canceled)

22. An electronic device, comprising:
one or more processors;
a memory; and
one or more application programs, stored in the memory and configured to be executed by the one or more processors to cause the electronic device to implement a method; wherein the method comprises:
establishing a second Bluetooth connection between the electronic device and a Bluetooth device in a case where a first Bluetooth connection has been established between the electronic device and the Bluetooth device; and disconnecting the first Bluetooth connection after the second Bluetooth connection is successfully established; or
establishing a second Bluetooth connection between the electronic device and a Bluetooth device in a case where a first Bluetooth connection has been established between the electronic device and the Bluetooth device; and transmitting preset data to the Bluetooth device via a data transmission channel after the second Bluetooth connection is successfully established and the data transmission channel is successfully established based on the second Bluetooth connection; or
establishing the other Bluetooth connection between the electronic device and the Bluetooth device in the case where one Bluetooth connection has been established between the electronic device and the Bluetooth device, the two Bluetooth connections correspond to different Bluetooth communication modes, respectively; and disconnecting a target Bluetooth connection after obtaining connection information of the target Bluetooth connection of the two Bluetooth connections, the target Bluetooth connection being at least one of the two Bluetooth connections.

23. (canceled)

24. A Bluetooth switching method, performed by an electronic device, and the method comprising:
establishing a second Bluetooth connection between the electronic device and a Bluetooth device in a case where a first Bluetooth connection has been established between the electronic device and the Bluetooth device; and
transmitting preset data to the Bluetooth device via a data transmission channel after the second Bluetooth connection is successfully established and the data transmission channel is successfully established based on the second Bluetooth connection.

25. The method as claimed in claim 24, wherein in a case where the preset data is transmitted via the first Bluetooth connection, the establishing a second Bluetooth connection between the electronic device and a Bluetooth device, comprises:
continuing transmitting the preset data via the first Bluetooth connection, and establishing the second Bluetooth connection between the electronic device and the Bluetooth device;
wherein the first Bluetooth connection is a classic Bluetooth connection, and the second Bluetooth connection is a low-energy audio Bluetooth connection.
